(19) United States
(12) Patent Application Publication
(10) Pub. No.: US 2013/0084555 A1
(43) Pub. Date: Apr. 4, 2013

(54) INFORMATION PROVIDING SYSTEM

(71) Applicant: ELMO COMPANY, LIMITED, Nagoya (JP)

(72) Inventors: Hiromasa Kaneko, Nagoya (JP); Yasushi Suda, Kasugai (JP)

(73) Assignee: ELMO COMPANY, LIMITED, Nagoya (JP)

(21) Appl. No.: 13/628,371

(22) Filed: Sep. 27, 2012

(30) Foreign Application Priority Data
Sep. 29, 2011 (JP) 2011-214462

(51) Int. Cl. G09B 7/00

(52) U.S. Cl. 434/362

(57) ABSTRACT

An information providing system is configured to provide each of students with an image of a material taken with a camera of an information providing device and allow interaction with the student. The teacher operates a tablet to set a plurality of answer options as available response choices for a question, such that the number of answer options is equal to or less than the number of answer buttons provided on each response clicker. The response clicker receives answer options specification data for specifying the answer options set by the teacher and provides initial notification that notifies each of the students of the answer buttons respectively corresponding to the plurality of answer options specified by the received answer options specification data.

### RELATED APPLICATIONS

The present application claims priority from Japanese application P2011-214462 filed on Sep. 29, 2011, the content of which is hereby incorporated by reference in its entirety for all purposes into this application.

### FIELD OF THE INVENTION

The present invention relates to an information providing system configured to provide each responder in audience with an image of a material taken with a camera and allow interaction with the responder.

### BACKGROUND OF THE INVENTION

In recent year, various presentation technologies for supporting the students' or the participants' learning or training in class and lectures have been proposed: for example, the technology proposed in JP H02-061689A. The technology of providing the audience with images of materials taken with a camera in classes or lectures has also been proposed in, for example, JP 2010-245690A.

The presentation technology proposed in JP H02-061689A provides the audience with questions, for example, visually in the form of paper or image display or by voice with a speaker, and obtains information relating to answers to each of the questions, e.g., statistical distribution of the answers to the question. The technology proposed in JP 2010-245690A provides the audience with the images of the materials taken with the camera. Combination of these technologies can support the audience's learning or training, while providing the audience with the images of the materials taken with the camera.

In the classes at school or in the lectures for some learning or training, the students or the participants as the audience generally have varying levels of understanding and learning. The teacher or the lecturer as the questioner may accordingly ask questions to check the level of understanding of the individual students or participants. In this case, the questioner may change the number of answer options set for each question or may create an appropriate question during the class or lecture. Neither the technology of JP H02-061689A that prepares in advance questions and answer keys selectable as answers to the questions nor the technology of JP 2010-245690A that aims to diversify the mode of providing the images taken with the camera, however, gives sufficient consideration to the varying levels of understanding of the audience. These technologies accordingly have insufficient versatility to allow the questioner to change the number of answer options set for each question as needed basis. Additionally, the participants may have varying experiences to participate in the lectures. It is accordingly desirable to enhance the convenience for the participants to reduce wrong device operations of the participants and facilitate the participants' selection of answers to each question through the device operations.

### SUMMARY OF THE INVENTION

Consequently, in order to address the problem described above, there is a need to provide a presentation technology of enhanced versatility employed to make a presentation while providing audience with an image taken with a camera.

In order to achieve at least part of the foregoing, the present invention provides various aspects and embodiments described below.

According to one aspect, there is provided an information providing system that provides each responder in audience with an image of a material taken with a camera and allows interaction with the responder. The information providing system includes: an information providing device configured to take the image of the material with the camera and output the image to an image display unit to be visible to the audience; a specific device operable by a questioner who asks a question to the audience; and a plurality of response devices provided for individual responders in the audience and configured to have a plurality of answer operation elements operable by each individual responder to answer the question. The information providing device, the specific device and the plurality of response devices are arranged to allow data transmission and reception. The specific device includes: an answer options specifier operable by the questioner to set a plurality of answer options as available responses to the question such that the number of the answer options is equal to or less than the number of the answer operation elements provided on each of the response devices; and a specific device transmitter/receiver involved in data transmission and reception and configured to transmit answer options specification data for specifying the plurality of answer options set by the answer options specifier. Each of the response devices includes a response device transmitter/receiver involved in data transmission and reception and configured to receive the answer options specification data transmitted from the specific device. Each of the response devices receives each individual responder's operation of each of the plurality of answer operation elements corresponding to each of the plurality of answer options specified by the received answer options specification data.

In the information providing system of this aspect that provides each responder in the audience with the image of the material taken with the camera and allows interaction with the responder, the questioner operates the specific device to set a plurality of answer options, i.e., the first answer option to the last answer option, for a question, such that the number of answer options is equal to or less than the number of answer operation elements provided on each of the response devices. This configuration enables the questioner to arbitrarily change the number of answer options set for each question within the range that the number of answer options does not exceed the number of answer operation elements, thus enhancing the versatility.

When the answer options are set by the questioner's operation of the specific device, the specific device transmits the answer options specification data for specifying the answer options set by the questioner via the specific device transmitter/receiver. Each of the response devices receives the answer options specification data via the response device transmitter/receiver. The response device sets the answer operation elements respectively corresponding to the plurality of answer options specified by the received answer options specification data, as the valid answer operation elements operable by each individual responder. This configuration advantageously invalidates the responder's operation of the other answer operation elements that do not correspond to any of the answer options.

According to one embodiment of the information providing system, each of the response devices may further include a notifier involved in notification of information to each individual responder and configured to provide initial notification that initially notifies the individual responder of the answer operation elements respectively corresponding to the plurality of answer options specified by the received answer options specification data. Such initial notification enables each individual responder operating the response device to recognize the initially notified answer operation elements as the valid answer operation elements for the question operable by the responder, thus enhancing the convenience.

According to another embodiment of the information providing system, the specific device may be structured as a tablet terminal that allows the questioner to make a drawing and transmits drawing track data representing a track of the drawing via the specific device transmitter/receiver to the information providing device. The information providing device may receive the drawing track data, generate a composite image by laying a drawn image represented by the received drawing track data over the image taken with the camera, and output the generated composite image to the information display unit. The drawing track obtained by the questioner's drawing operation with the specific device can thus be related to the question. This enables the questioner to provide the responders with the composite image including the drawn image that relates the original image of the material to the question, thus further enhancing the versatility for the questioner.

The drawing track data may include a character drawn image created by the questioner using the specific device as the tablet terminal. This configuration enables the questioner to create any appropriate question to ask for the responder's response and provide each of the responders with the composite image including the image of the material and the drawn image of a question statement, thus further enhancing the versatility. When the questioner uses the specific device structured as the tablet terminal to distinctly draw the plurality of answer options, the drawn image of such answer options is included in the drawing track data. This enables each of the responders to visually and distinctly recognize the plurality of answer options, i.e., the first answer option to the last answer option, together with the image of the material in the composite image, thus further enhancing the convenience.

According to yet another embodiment of the information providing system, the information providing device may further include a wireless data communication controller and allow wireless data transmission and reception between the specific device and the plurality of response devices via the wireless data communication controller. The specific device may wirelessly transmit the answer options specification data via the specific device transmitter/receiver to the wireless data communication controller of the information providing device. Each of the response devices may wirelessly receive the answer options specification data via the response device transmitter/receiver from the wireless data communication controller of the information providing device. The information providing device can thus be used as the relay station of data transmission and reception to receive data wirelessly transmitted from both the specific device and each of the response devices. The information providing device is allowed to summarize the answers of the responders who operate the answer operation elements provided on the individual response devices in correlation to the plurality of answer options set on the specific device by the questioner.

According to another embodiment of the information providing system, each of the response devices may generate operated answer operation element specification data for specifying one of the answer operation elements operated by each individual responder among the plurality of initially notified answer operation elements and transmit the operated answer operation element specification data via the response device transmitter/receiver to the information providing device. The notifier of the response device may provide distinct notification that distinctly notifies the individual responder of the answer operation element operated by the individual responder among the plurality of initially notified answer operation elements. This enables the information providing device to readily check the answer operation elements of the individual response devices operated by the individual responders. This also facilitates each responder who operates the response device to check which of the answer operation elements is operated by the responder after the operation.

According to yet another embodiment of the information providing system, the specific device may further include a correct answer option specifier configured to set a correct answer option to the question by the questioner's operation. The specific device may transmit correct answer option specification data for specifying the correct answer option set by the correct answer option specifier via the specific device transmitter/receiver to at least the information providing device. Each of the response devices may receive the correct answer option specification data via the response device transmitter/receiver through the information providing device or directly from the specific device. When the answer operation element operated by the individual responder among the plurality of initially notified answer operation elements matches with an answer operation element specified by the received correct answer option specification data, the notifier of the response device may distinctly notify the individual responder of the matching answer operation element operated by the individual responder. This facilitates each responder who operates the response device to recognize that the operated answer operation element matches with the correct answer operation element corresponding to the correct answer option to the question, i.e., that the responder selects the correct answer option. The information providing system of this configuration accordingly enhances the responder's motivation and gives the responder a sense of achievement.

According to still another embodiment of the information providing system, each of the plurality of answer operation elements provided on each of the response devices may have a color light-emitting element configured to change color of light. The notifier of the response device may control lighting of the color light-emitting element to light up the color light-emitting element in different colors for the initial notification and for the distinct notification. This notifies each responder who operates the response device of the valid answer operation elements for the question operable by the responder by light emission in a predetermined color, and additionally notifies the responder of the answer operation element operated by the responder or the correct answer operation element corresponding to the correct answer option by light emission in a different color.

According to yet another embodiment of the information providing system, each of the response devices may have a light-emitting element configured to externally emit light, and a light emission controller configured to provide initial lighting that initially lights up the light-emitting element, when one of the initially notified answer operation elements is operated by each individual responder. This enables the questioner to recognize each responder who makes a response to the question by light emission of the light-emitting element provided on the response device operated by the responder.

According to another embodiment of the information providing system, the specific device may further include an arbitrary answer option specifier configured to set an arbitrary answer option among the plurality of answer options by the questioner's operation. The specific device may transmit arbitrary answer operation specification data for specifying the arbitrary answer option set by the arbitrary answer option specifier via the specific device transmitter/receiver to at least the information providing device. Each of the response devices may receive the arbitrary answer operation specification data via the response device transmitter/receiver through the information providing device or directly from the specific device. When the answer operation element operated by the individual responder among the plurality of initially notified answer operation elements matches with an answer operation element specified by the received arbitrary answer option specification data, the light emission controller of the response device may control lighting of the light-emitting element distinguishably from the initial lighting. This enables the questioner to readily check which of the responders selects which of the plurality of answer options set for the question by light emission of the light-emitting element provided on the response device operated by the responder.

According to another embodiment of the information providing system, the light emission controller of the response device may control lighting of the light-emitting element to distinguishably light the light-emitting element in a different lighting mode from the initial lighting. Such visual indication facilitates the question to check which of the responders who answer the question selects which of the answer options.

The present invention may be achieve by various other aspects and embodiments, for example, an information providing method and an information providing device, a presentation system, integrated circuits structured to implement the functions of the method or the device, computer program configured to implement the functions of the method or the device, and storage media in which such computer programs are stored.

### BRIEF DESCRIPTION OF THE DRAWINGS

FIG. 1 illustrates the configuration of an information providing system according to one embodiment of the invention;

FIG. 2 illustrates a front view of a tablet;

FIG. 3 illustrates a response clicker;

FIG. 4 is a block diagram illustrating the internal structure of an information providing device;

FIG. 5 is a block diagram illustrating the internal structure of the tablet;

FIG. 6 is a block diagram illustrating the internal structure of the response clicker;

FIG. 7 illustrates a sequence of wireless data transmission and reception between the information providing device and the tablet and between the information providing device and each individual response clicker;

FIG. 8 illustrates a procedure by the teacher and a procedure by each of the students during education support using the information providing device;

FIG. 9 illustrates the detailed procedures at the step of providing the image and the step of setting the question and the answer options, in relation to the operations of the respective devices and the data transmission and reception there between;

FIG. 10 illustrates the detailed procedures at the teacher's step of accepting answers and the student's step of making a response, in relation to the operations of the respective devices and the data transmission and reception there between;

FIG. 11 illustrates the detailed procedures at the teacher's step of providing the correct answer and the student's step of recognizing the correct answer, in relation to the operations of the respective devices and the data transmission and reception there between;

FIG. 12 illustrates the detailed procedures at the teacher's step of checking the answer statuses and the student's step of informing the teacher of the student's answer status with the response clicker 40, in relation to the operations of the respective devices and the data transmission and reception there between;

FIG. 13 illustrates the relationship between the drawing area of the tablet and the imaging area RA of the information providing device;

FIG. 14 illustrates a state of providing the image including the teacher's drawing;

FIG. 15 illustrates the system configuration of the information providing system according to one modification; and

FIG. 16 is a block diagram illustrating the internal structure of the tablet according to the modification.

### DETAILED DESCRIPTION

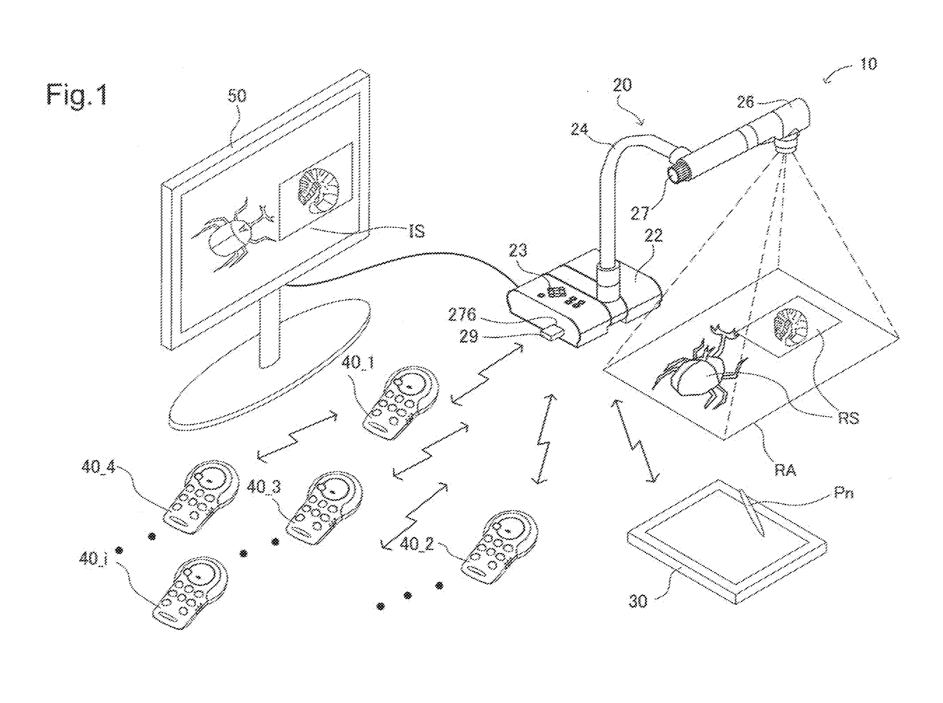

The following describes some embodiments of the invention with reference to the accompanied drawings. More specifically, the embodiment described below is an information providing system for education support operated by a teacher to provide a plurality of students with the image of a material and to demand answers from the students. FIG. 1 illustrates the configuration of an information providing system 10 according to one embodiment of the invention.

As shown in FIG. 1, the information providing system 10 includes an information providing device 20, a tablet 30 operated by a teacher as a questioner, a plurality of response clickers 40 individually operated by students as audience or responders, and a TV display 50. The information providing device 20 enables wireless data transmission and reception to and from the tablet 30 and the plurality of response clickers 40, takes an image of a material RS placed in an imaging area RA and outputs the image to the TV display 50 via a cable for data transfer. The output image is displayed as a displayed image IS on the screen of the TV display 50. According to this embodiment, a specimen of adult beetle (Coleoptera) and a photograph of grub are placed as the material RS in the imaging area RA. The material RS mounted on the imaging area RA may be arbitrarily replaced with any of other references such as documents, maps, pictures and books, based on the teacher's question.

The information providing device 20 includes a main unit 22 placed on, for example, a desk, an operation unit 23 provided on the main unit 22, a support rod 24 extended upward from the main unit 22, a camera head 26 attached to an end of the support rod 24, and a zoom control 27. In the information providing device 20, the camera head 26 internally has a CCD video camera and takes the image of the material RS placed on, for example, the desk at a rate of specified number of frames per unit time. In this embodiment, the information providing device 20 takes the image of the material RS at the rate of 60 frames per second. A wireless USB transmitter/receiver 29 is connected to a USB interface 276 provided on the main unit 22 to transmit and receive specified data to and from the tablet 30 and each individual response clicker 40. The information providing device 20 accordingly serves as a relay station for wireless data transmission and reception. A wireless communication technology using a specified frequency (described later) is employed for wireless data transmission and reception according to this embodiment, but another wireless technology, such as Bluetooth, infrared, or wireless LAN, may be employed for information transmission and reception. The transmitter/receiver 29 may be built in the casing of the information providing device 20.

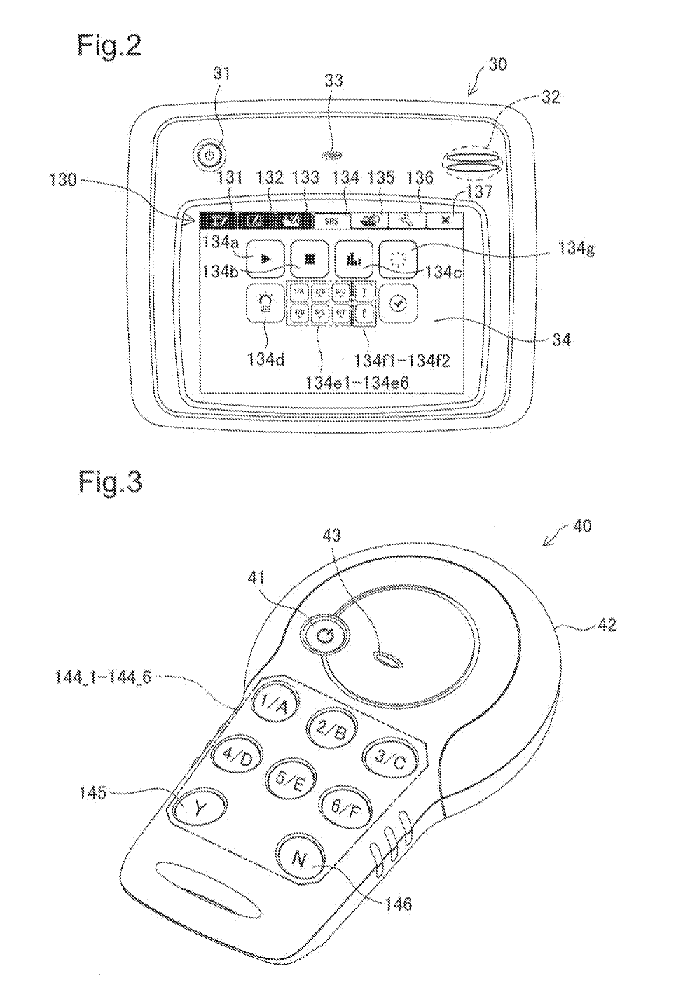

The following describes the tablet 30 and the response clickers 40. FIG. 2 illustrates a front view of the tablet 30. As illustrated, the tablet 30 includes a power switch 31, a microphone 32 as a sound collector, and a power lamp 33 provided along the upper end of the tablet body and a tablet operation unit 34 provided below these components 31 to 33. The tablet 30 transmits voice data collected by the microphone 32, more specifically, voice data of question statements read out by the teacher to a speaker (not shown). A group of function switches 130 is displayed in the upper portion of the tablet operation unit 34 of the tablet 30, and an area below the function switch group 130 is used as a tablet operating area corresponding to each of the function switches 130. The function switch group 130 includes a camera switch 131, a drawing switch 132, a file open switch 133, a clicker directing switch 134, a save switch 135, a maintenance switch 136, and a lock switch 137. Among these switches, the camera switch 131, the drawing switch 132 and the clicker directing switch 134 are related to the questioning and answering operations according to the embodiment by the teacher and the students described below.

When the camera switch 131 is activated by the teacher, the tablet 30 displays various switches on the tablet operation unit 34 to allow the operator of the tablet 30 to adjust the imaging conditions, such as camera zooming, of the information providing device 20, and wirelessly transmits imaging adjustment data reflecting the operations of the displayed various switches to the information providing device 20. When the drawing switch 132 is activated by the teacher, the tablet 30 generates data of lines drawn with a tablet pen Pn or the teacher's fingertip as track data on the tablet operation unit 34 and wirelessly transmits the track data to the information providing device 20. When the clicker directing switch 134 is activated by the teacher, the tablet 30 displays various switches on the tablet operation unit 34 as shown in FIG. 2. The displayed switches include an answer start switch 134a, an answer end switch 134b, an answer status display switch 134c, an answer status check switch 134d, answer option setting switches 134e, true and false setting switches 134f and a reset switch 134g. Among these switches, the answer start switch 134a, the answer end switch 134b, the answer status display switch 134c, the answer status check switch 134d, the answer option setting switches 134e and the reset switch 134g are related to the questioning and answering operations according to the embodiment by the teacher and the students.

When the answer start switch 134a is activated by the teacher, the tablet 30 wirelessly transmits answer start data to the information providing device 20. When the answer end switch 134b is activated by the teacher, the tablet 30 wirelessly transmits answer end data to the information providing device 20. When the answer status display switch 134c is activated by the teacher, the tablet 30 wirelessly transmits graph display data to the information providing device 20 to display a graph showing the answer statuses of the students. When the answer status check switch 134d is activated by the teacher, the tablet 30 wirelessly transmits answer status display data to the information providing device 20 to enable the teacher to check the answer statuses of the individual students by the students' individual response clickers 40. The answer option setting switches 134e include the same number of switches as the number of answer buttons provided on each response clicker 40. There are six answer option setting switches 134e 134e_1 to 134e_6 according to this embodiment. The tablet 30 wirelessly transmits data for specifying available response choices (answer options) to the information providing device 20, based on the operation of one of these setting switches 134e_1 to 134e_6. The reset switch 134g is operated by the teacher to terminate one question and move on to a next question. In response to the teacher's operation of this switch 134g, the tablet 30 wirelessly transmits data for resetting the answer options to the information providing device 20. Such wireless data transmission and reception between the tablet 30 and the information providing device 20 and the accompanied operations of the information providing device 20 and the tablet 30 will be described later in association with the questioning and answering operations.

FIG. 3 illustrates the response clicker 40. The response clickers 40 are provided for the individual students and are shown as response clickers 40_1 to 40_i in FIG. 1. The response clicker 40 includes a power switch 41, a top light-emitting unit 42, a power lamp 43, answer buttons 144, an Yes button 145, and a No button 146. The top light-emitting unit 42 of the response clicker 40 light up as described later, when the student presses or operates the answer buttons 144 or receives the teacher's requirement, e.g., answer status display, via the tablet 30. The answer buttons 144 include the same number of buttons as the number of the answer option setting switches 134e provided on the tablet 30. There are six answer buttons 144_1 to 144_6 according to this embodiment. The six answer buttons 144_1 to 144_6 provided on the response clicker 40 have one-to-one-correspondence to the six answer option setting switches 134e_1 to 134e_6 provided on the response clicker 40. The button arrangement on the response clicker 40 is substantially identical with the switch arrangement on the tablet 30. When the student presses or operates one of the answer buttons 144_1 to 144_6, the response clicker 40 wirelessly transmits data for identifying the operated answer button 144 to the information providing device 20. Similarly, when the student presses or operates the Yes button 145 or the No button 146, the response clicker 40 wirelessly transmits Yes data or No data to the information providing device 20. Such wireless data transmission and reception between each individual response clicker 40 and the information providing device 20 and the accompanied operations of the information providing device 20 and the response clicker 40 will be described later in association with the questioning and answering operations.

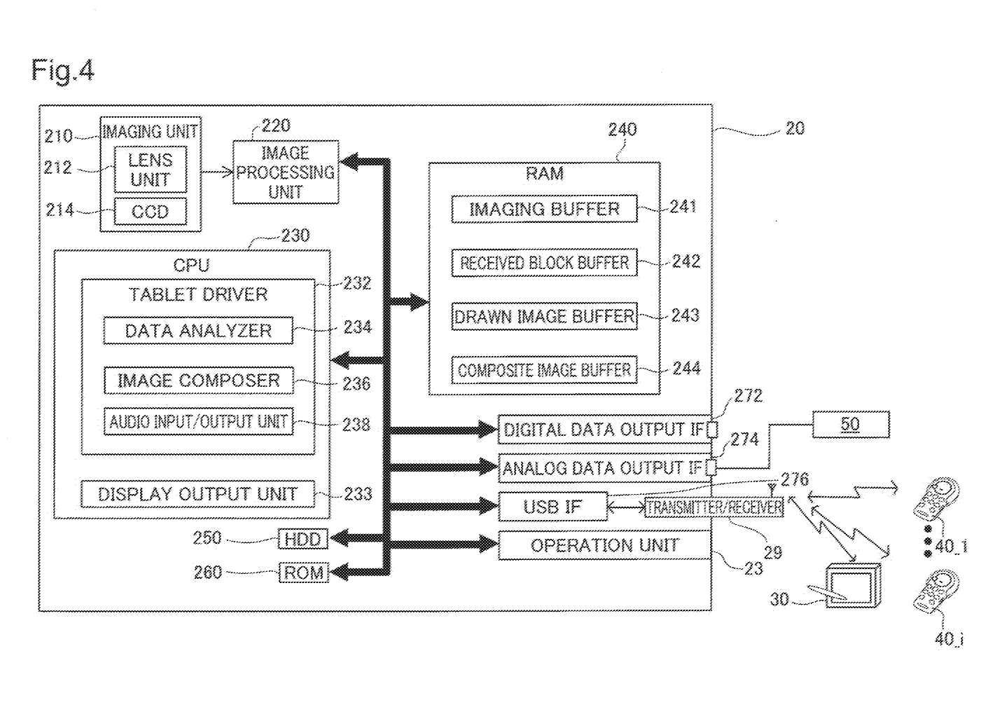

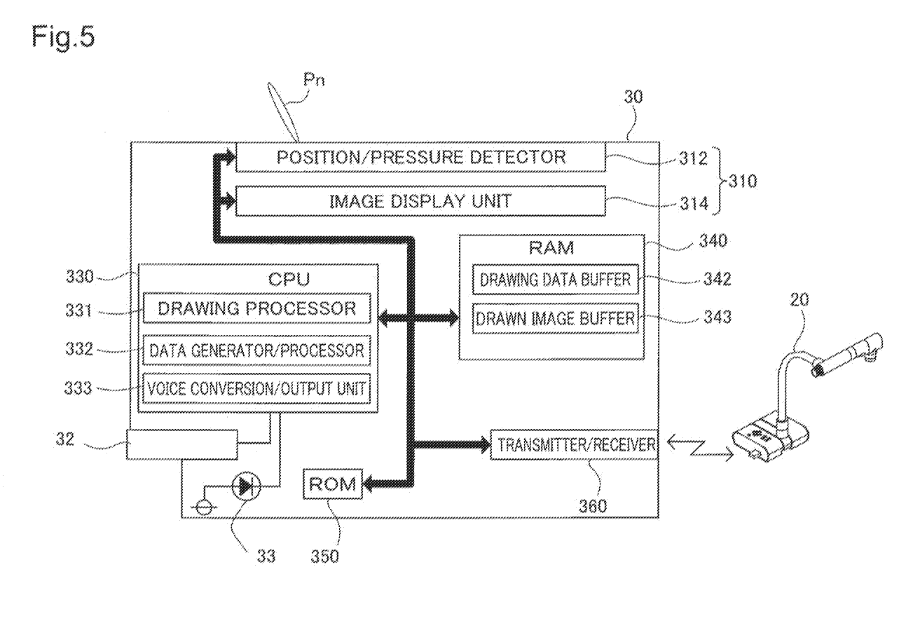

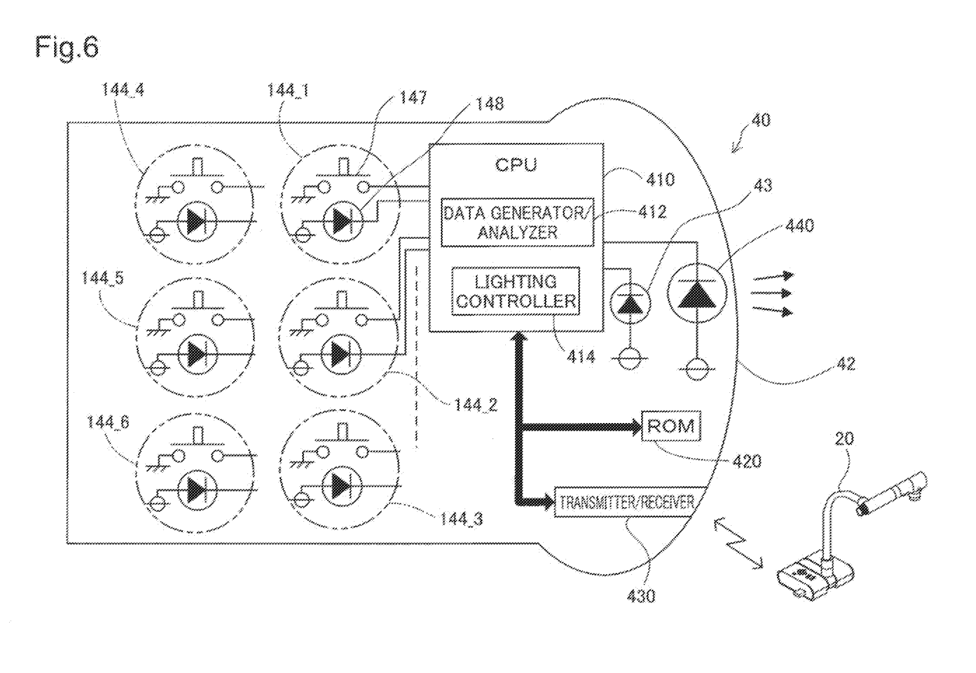

The following describes the electrical configurations and the functions of the respective devices. FIG. 4 is a block diagram illustrating the internal structure of the information providing device 20. FIG. 5 is a block diagram illustrating the internal structure of the tablet 30. FIG. 6 is a block diagram illustrating the internal structure of the response clicker 40.

As shown in FIG. 4, the information providing device 20 includes an imaging unit 210, an image processing unit 220, a CPU 230, a RAM 240, a hard disk drive (HDD) 250 and a ROM 260. The information providing device 20 also includes a digital data output interface (digital data output IF) 272, an analog data output interface (analog data output IF) 274, the USB interface (USB IF) 276 and the operation unit 23. The wireless USB transmitter/receiver 29 of transmitting and receiving specific data to and from the tablet 30 and to and from each individual response clicker 40 is connected to the USB IF 276 as explained above. This transmitter/receiver 29 is involved in wireless transmission and reception between the information providing device 20 and the tablet 30, as well as wireless transmission and reception between the information providing device 20 and each individual response clicker 40. Such wireless transmission and reception will be described later in association with the questioning and answering operations.

The imaging unit 210 includes a lens unit 212 and a charge-coupled device (CCD) 214. The CCD 214 is provided as an image sensor to receive the light transmitted through the lens unit 212 and convert the received light into electrical signal. The image processing unit 220 includes an AGC (Automatic Gain Control) circuit and a DSP (Digital Signal Processor). The image processing unit 220 inputs the electrical signal from the CCD 214 and generates image data. The image data generated by the image processing unit 220 is stored in an imaging buffer 241 provided in the RAM 240.

The CPU 230 controls the operations of the entire information providing device 20 and loads and executes a program stored in the HDD 250 or the ROM 260 to work as a tablet driver 232 and a display output unit 233. The tablet driver 232 includes a data analyzer 234, an image composer 236 and an audio input/output unit 238. These processing components will be described later in association with the questioning and answering operations.

The RAM 240 includes the imaging buffer 241, a received block buffer 242, a drawn image buffer 243 and a composite image buffer 244. These buffers are provided to store data required for storage in the course of drawn image display process described later. The details will be described later in association with the questioning and answering operations.

The digital data output IF 272 encodes the generated image data or the composite image data and outputs the encoded image data in the form of digital signal to the outside of the information providing device 20. The analog data output IF 274 processes the generated image data or the composite image data by digital-to-analog conversion and outputs the converted image data in the form of RGB data to the outside of the information providing device 20. The analog data output IF 274 includes a D-A converter (DAC). The digital data output IF 272 and the analog data output IF 274 respectively have a connector for cable connection. According to this embodiment, the TV display 50 is connected to the analog data output IF 274.

As shown in FIG. 5, the tablet 30 includes a touchscreen 310, a CPU 330, a RAM 340, a ROM 350 and a transmitter/receiver 360. The touchscreen 310 corresponds to the tablet operation unit 34 shown in FIG. 2 and is provided as a projected capacitive touchscreen. This touchscreen 310 includes a position/pressure detector 312 and an image display unit 314. The position/pressure detector 312 senses a change in capacitance between the conductive film of the touchscreen 310 and the tablet pen Pn or the fingertip to detect the current pen tip position or the current fingertip position, the moving track of the pen tip position and the fingertip position, and the press of the pen tip or the fingertip. The image display unit 314 is provided as a liquid crystal display of the touchscreen 310 to display an image corresponding to the operation of each of the function switches 130. For example, when the clicker directing switch 134 is operated, the various switches including the answer start switch 134a and the answer option setting switches 134e are displayed on the touchscreen 310 as shown in FIG. 2.

The CPU 330 includes a drawing processor 331, a data generator/processor 332, and a voice conversion/output unit 333. The drawing processor 331 processes the moving track of the pen tip of the tablet pen Pn or the fingertip on the surface of the touchscreen 310 detected by the position/pressure detector 312 as drawing track data of a drawn image and wirelessly transmits the drawing track data to the information providing device 20 via the transmitter/receiver 360. The data generator/processor 332 receives the operation of any of the various switches, e.g., the answer start switch 134a, the answer end switch 134b, or the answer option setting switches 134e, and wirelessly transmits data corresponding to the operated switch to the information providing device 20 via the transmitter/receiver 360. The voice conversion/output unit 333 converts voice data that is collected by the microphone 32, for example, when the teacher reads a question statement, and transmits the converted voice data to the speaker (not shown). The transmitter/receiver 360 is involved in such wireless transmission and reception. Such wireless transmission and reception and the accompanied operations of the tablet 30 will be described later in association with the questioning and answering operations. The RAM 340 includes a drawing data buffer 342 and a drawn image buffer 343. Drawn image data (drawing track data) of a line image drawn with the tablet pen Pn is temporarily stored in these buffers 342 and 343, prior to data transmission.

As shown in FIG. 6, the response clicker 40 includes a CPU 410, a ROM 420, a transmitter/receiver 430 and a top display lamp 440. The response clicker 40 also has switch contacts 147 and button light-emitting lamps 148 provided corresponding to the six answer buttons 144_1 to 144_6. The switch contact 147 detects the press of the corresponding answer button 144 and outputs an ON signal to the CPU 410. The CPU 410 receives this ON signal and identifies which answer button 144 is pressed or operated. The button light-emitting lamp 148 is structured as a color-variable light source including a plurality of LED light sources emitting different color lights. The response clicker 40 similarly has switch contacts 147 and button light-emitting lamps 148 corresponding to the Yes button 145 and the No button 146 (FIG. 2). These switch contacts 147 and button light-emitting lamps 148, as well as the Yes button 145 and the No button 146 are not directly related to the features of the invention and are thus omitted from the illustration.

The CPU 410 includes a data generator/analyzer 412 and a lighting controller 414. The data generator/analyzer 412 generates and outputs (wirelessly transmits) data for identifying one of the answer buttons 144_1 to 144_6 pressed or operated by the student, while analyzing and checking data wirelessly received via the transmitter/receiver 430. The lighting controller 414 controls lighting of the power lamp 43, as well as lighting of the top display lamp 440 provided inside the colored translucent top light-emitting unit 42 and the button light-emitting lamps 148 of the respective answer buttons 144. The wireless transmission and reception via the transmitter/receiver 430 and the lighting control by the lighting controller 414 will be described later in association with the questioning and answering operations.

The following sequentially describes wireless data transmission and reception between the information providing device 20 and the tablet 30 and between the information providing device 20 and each individual response clicker 40 included in the information providing system 10 described above and an example of education support by this information providing system 10.

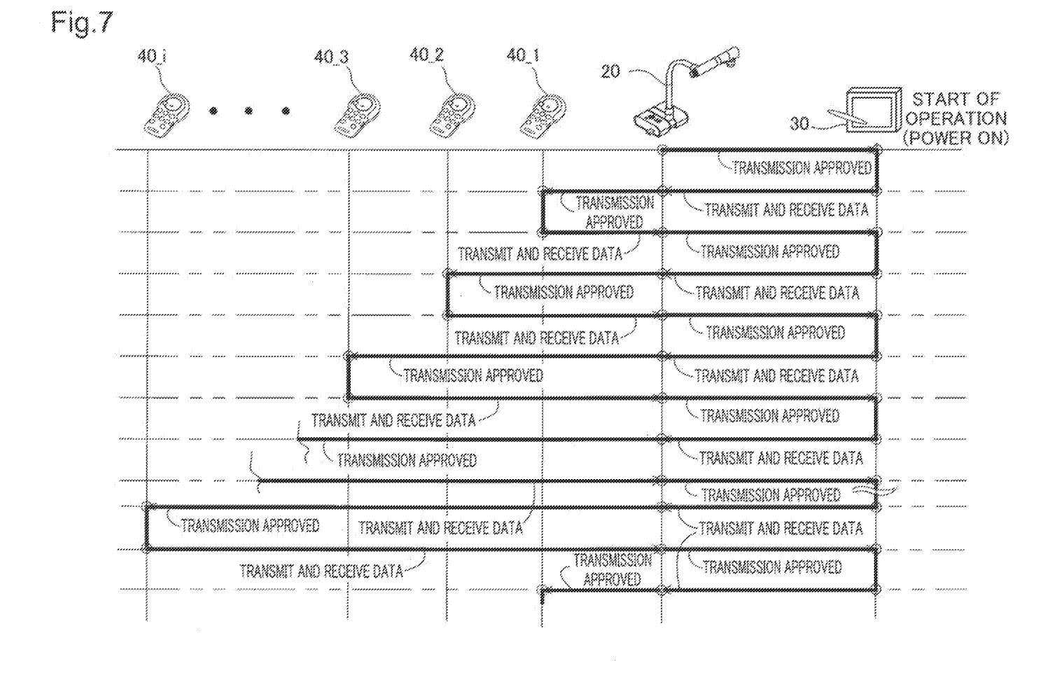

In the information providing system 10 of this embodiment, the transmitter/receiver 29 of the information providing device 20 is used as the relay station for wireless data transmission and reception between the information providing device 20 and the tablet 30 and between the information providing device 20 and each individual response clicker 40. The data transmission and reception between the tablet 30 and the information providing device 20 and the data transmission and reception between each individual response clicker 40 and the information providing device 20 are respectively performed via the transmitter/receiver 360 of the tablet 30 and the transmitter/receiver 430 of each response clicker 40. The coverage of data transmission and reception is assumed to be a classroom, and a specified frequency in a certain frequency band that ensures smooth data transmission and reception in the classroom, for example, 2.4 GHz, is employed for wireless data transmission and reception. FIG. 7 illustrates a sequence of wireless data transmission and reception between the information providing device 20 and the tablet 30 and between the information providing device 20 and each individual response clicker 40. The wireless data transmission and reception described below is performed via the transmitter/receiver 29 of the information providing device 20 and the transmitter/receiver 360 of the tablet 30 or the transmitter/receiver 430 of each individual response clicker 40.

As illustrated in FIG. 7, when the information providing device 20, the tablet 30 and the individual response clickers 40 are respectively powered ON to start the operation of the information providing system 10, the information providing device 20 wirelessly transmits data at transmission timings of specified time intervals, for example, transmission timings of 15 ms intervals. Data transmitted at each transmission timing includes an identification signal for identifying one of the tablet 30 and the response clickers 40 and a transmission approval signal for approving data transmission to the information providing device 20. More specifically, the information providing device 20 wirelessly transmits data including one of the identification signal for the tablet 30 and the identification signals for the respective response clickers 40 and the transmission approval signal. The tablet 30 and the individual response clickers 40 receive the data transmitted at each transmission timing from the information providing device 20. When the identification signal corresponding to its own self is included in the received data, the corresponding one of the tablet 30 and the response clickers 40 wirelessly transmits data in response to the transmission approval signal included in the received data. When the corresponding one of the tablet 30 and the response clickers 40 is not currently operated by the teacher or the student, there is generally little requirement of data transmission. When receiving the transmission approval signal in such circumstances, the corresponding one of the tablet 30 and the response clickers 40 may transmit null data representing the absence of data or may not transmit data at all. When the identification signal corresponding to its own self is not included in the data received from the information providing device 20, on the other hand, the corresponding one of the tablet 30 and the response clickers 40 does not transmit data to the information providing device 20.

The information providing device 20 wirelessly transmits data including the identification signal for the tablet 30 at the first transmission timing and wirelessly transmits data including the identification signal for one of the plurality of response clickers 40, e.g., the response clicker 40_1, at the next transmission timing. The information providing device 20 then wirelessly transmits data including the identification signal for the tablet 30 again at the subsequent transmission timing and wirelessly transmits data including the identification signal for a next response clicker 40, e.g., the response clicker 40_2, at the next transmission timing. In this manner, the information providing device 20 wirelessly transmits data including the identification signal for the tablet 30 every time before wirelessly transmitting data including the identification signal for each of the response clickers 40 to the corresponding one of the response clickers 40 included in the information providing system 10. Such data transmission is described more in detail, in relation to the tablet 30 and the respective response clickers 40 as the data receivers. The information providing device 20 sequentially performs wireless data transmission to the tablet 30, wireless data transmission to the response clicker 40_1, wireless data transmission to the tablet 30 again, wireless data transmission to the response clicker 40_2, and wireless data transmission to the tablet 30 again. In other words, the information providing device 20 repeats wireless data transmission to the tablet 30 and wireless data transmission to one of the response clickers 40. As shown in FIG. 7, the information providing device 20 wirelessly transmits data to the tablet 30 every time before wirelessly transmitting data to one of the response clickers 40. This increases the frequency of wireless data transmission to the tablet 30, so as to increase accumulation of the data transmission time from the tablet 30 and enable the required data transmission.

When receiving the data wirelessly transmitted from the information providing device 20, the tablet 30 wirelessly transmits required data to the information providing device 20 in the specified time interval of data transmission (e.g., 15 ms) after reception of the transmission approval signal included in the received data. Similarly, when receiving the data including the identification signal for one of the response clickers 40, the corresponding one of the response clickers 40 wirelessly transmits required data to the information providing device 20 in the specified time interval of data transmission (e.g., 15 ms) after reception of the transmission approval signal included in the received data. The data transmitted from the response clicker 40 is only the data for identifying one of the answer buttons 144 as described later. The short time interval of, for example, 15 ms is thus sufficient for data transmission from the response clicker 40. Immediately after the operation start of the information providing system 10 by the power-on operations of the respective devices, when receiving the transmission approval signal from the information providing device 20, each of the response clickers 40 wirelessly transmits an ON signal representing the answer ready state to the information providing device 20. This ON signal may be used to check the attendance of each student.

With the aim of supporting education, the information providing system 10 of the embodiment may be used to provide the students with an image taken by the information providing device 20 and displayed on the TV display 50, while the teacher asks the students a relevant question and the students answer the question. Each of the students simply presses one of the answer buttons 144 on the response clicker 40 that is provided for each individual student, to answer the question. The data transmission from the response clicker 40 only transmits data for identifying the selected one of the answer buttons 144. The tablet 30 operated by the teacher, on the other hand, has various functions described above with reference to FIG. 2, e.g., the function of adjusting the imaging conditions of the information providing device 20, the drawing function with the tablet pen Pn, the function of setting answer options, and the functions of providing answer start and answer end instructions. The tablet 30 accordingly has the significantly higher demands for data transmission and reception and has the significantly greater amount of data to be transmitted. By taking into account these facts, the information providing system 10 of the embodiment employs the data transmission sequence as shown in FIG. 7 to increase accumulation of the data transmission time from the tablet 30 and enable the required data transmission.

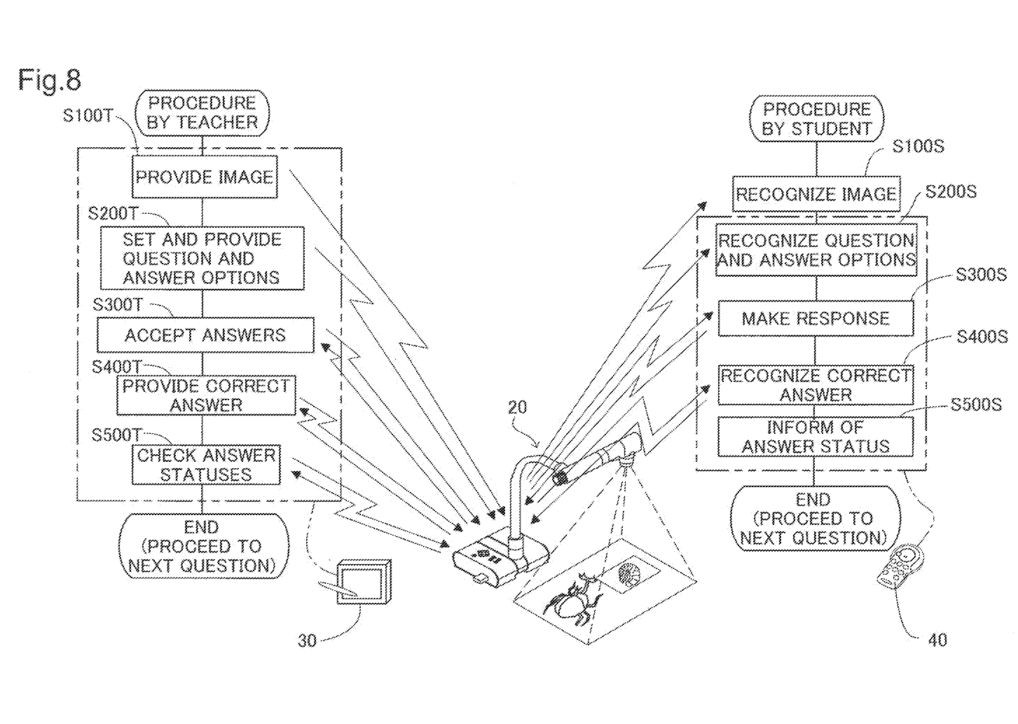

The information providing device 20 may be set to perform wireless data transmission and reception only to and from the tablet 30 in specified time periods as those described below. For example, immediately after the operation start of the information providing system 10 by the power-on operations of the respective devices, during initial adjustment of the imaging conditions of the information providing device 20 through the operations of the various switches displayed by activation of the camera switch 131 on the tablet 30, or during replacement of the material RS as the imaging object, there is generally no response from any of the students and data transmission from the individual response clickers 40 is thereby not required. Data transmission and reception to and from the response clickers 40 is also not generally required before the teacher provides instruction on answering a question or before the teacher sets answer options for the question. According to the embodiment, wireless data transmission and reception may thus be allowed only between the tablet 30 and the information providing device 20 in such specified time periods. Data transmission and reception may follow the data transmission sequence as shown in FIG. 7, in the other time periods, i.e., the time period after the teacher provides instruction on answering a question or after the teacher sets answer options for the question. The following describes an example of education support by the information providing system 10, accompanied with data transmission and reception between the information providing device 20 and the tablet 30 and between the information providing device 20 and each individual response clicker 40. FIG. 8 illustrates a procedure by the teacher and a procedure by each of the students during education support using the information providing device 20.

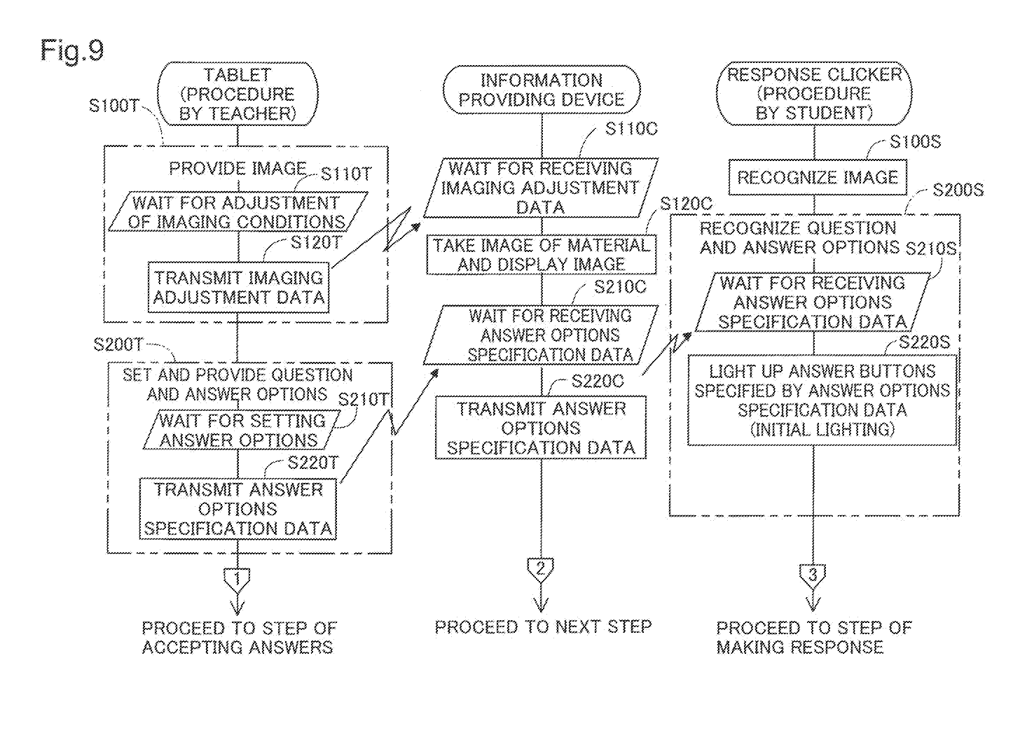

As shown in FIG. 8, the teacher first provides the students with an image taken by the information providing device 20 and displayed on the TV display 50 (step S100T). More specifically, the information providing device 20 activates the imaging unit 210 (FIG. 4) to take an image of the material RS mounted on the imaging area RA and activates the imaging unit 210 and the image processing unit 220 to generate image data. The information providing device 20 then outputs the generated image data to the TV display 50 and thereby provides the students with the image displayed on the TV display 50. Each of the students recognizes the image displayed on the TV display 50 (step S100S). The teacher then sets a question and available response choices as answer options and provides the students with the question and the answer options (step S200T). Each of the students recognizes the question and the answer options (step S200S). FIG. 9 illustrates the detailed procedures at the step of providing the image and the step of setting the question and the answer options, in relation to the operations of the respective devices and the data transmission and reception there between.

As shown in FIG. 9, at step S100T of providing the image, the tablet 30 operated by the teacher waits for adjustment of imaging conditions including focusing and zooming (step S110T). When the imaging conditions of the information providing device 20 are adjusted through the teacher's operations of the various switches displayed by activation of the camera switch 131 (FIG. 2), the tablet 30 activates the data generator/processor 332 of the CPU 330 (FIG. 5) to generate imaging adjustment data reflecting the switch operations and wirelessly transmits the generated imaging adjustment data from its transmitter/receiver 360 to the transmitter/receiver 29 of the information providing device 20 (FIG. 4) (step S120T). The adjustment of the imaging conditions of the information providing device 20 is often performed in the state independent of the operations of the response clickers 40, for example, before setting of a question by the teacher, during a change to another question, during replacement of the material RS. According to this embodiment, in the state independent of the operations of the response clickers 40, the tablet 30 wirelessly transmits the imaging adjustment data reflecting the operations of the various switches displayed by the activation of the camera switch 131, together with the identification signal for the tablet 30 itself, to the information providing device 20. The teacher may adjust the focus and the zoom after providing answer start instruction. Wireless transmission of the imaging adjustment data from the tablet 30 to the information providing device 20 in such circumstances is, on the other hand, performed during the specified time interval of data transmission after the tablet 30 receives data including the identification signal and the transmission approval signal from the information providing device 20 as described above with reference to FIG. 7.

The information providing device 20 waits for receiving the imaging adjustment data from the tablet 30 (step S110C). When receiving the imaging adjustment data, the information providing device 20 actually adjusts the imaging conditions of the imaging unit 210 (FIG. 4) based on the received imaging adjustment data. The information providing device 20 then takes an image of the material RS (specimen of adult beetle (Coleoptera) and photograph of grub) placed in the imaging area RA as shown in FIG. 1 and outputs the image to the TV display 50 to display the image (step S120C). The students then recognize the image displayed on the TV display 50, i.e., the image of the specimen of adult beetle and the photograph of grub (step S100S).

When the information providing device 20 receives the imaging adjustment data from the tablet 30, it is expected that the teacher subsequently sets a question and answer options, provides the students with the question and the answer options and provides answer start instruction. After receiving the imaging adjustment data from the tablet 30, the information providing device 20 repeatedly transmits the data including the identification signal for the tablet 30 or each of the response clickers 40 and the transmission approval signal to the tablet 30 and the individual response clickers 40 as described in FIG. 7. In the case that non-reception of imaging adjustment data from the tablet 30 continues for a specified time interval, after this specified time interval, the information providing device 20 repeatedly transmits the data including the identification signal for the tablet 30 or each of the response clickers 40 and the transmission approval signal to the tablet 30 and the individual response clickers 40 as described in FIG. 7.

At subsequent step S200T, the tablet 30 waits until the teacher sets answer options (step S210T). During this waiting period, the teacher sets a question and provides the students with the question. For example, when the image provided to the students is the image of the specimen of adult beetle and the photograph of grub as shown in FIG. 1, the teacher sets a question relating to this image. The teacher may set any of various questions according to the students' levels of learning or understanding: for example, whether the beetle passes the winter in the form of adult or in the form of grub (question 1); whether the beetle passes the winter in the form of adult, in the form of grub, or in both the form of adult and the form of grub (question 2); and how many times the grub casts off the skin (question 3), and provide the students with the question. The teacher may provide the students with the question by any of various methods, for example, writing the question statement on the blackboard in the classroom or reading out the question statement. When the teacher reads out the question statement, the tablet 30 collects the teacher's voice by its microphone 32 and outputs the collected voice to the speaker. The students hear the voice output from the speaker to recognize the question (step S200S). According to another embodiment, the information providing device 20 may be equipped with a microphone to enable the students to recognize the question by the voice collected by the microphone of the information providing device 20. In this configuration, the microphone 32 may be omitted from the tablet 30.

The teacher sets available response choices as answer options for the question after setting the question. Two answer options are set for the question 1, whereas three answer options are set for the question 2. Two answer options (casting off only once and casting off twice) to four answer options (casing off only once to casting off four times) may be set for the question 3. The number of answer options depends on the question, so that the teacher may set answer options for a question every time after setting the question.

The tablet 30 is involved in setting the answer options. More specifically, the teacher operates any one of the six answer option setting switches 134e_1 to 134e_6 provided on the tablet 30 to set the answer options. According to this embodiment, the upper limit of answer options is determined by the number of answer option setting switches 134e displayed on the tablet 30 by the activation of the clicker directing switch 134, i.e., the number of answer buttons 144 (six) provided on the response clicker 40. Any arbitrary number that is not greater than six may be set as the number of answer options. For example, the teacher's operation of the answer option setting switch 134e_3 sets three answer options; the teacher's operation of the answer option setting switch 134e_4 sets four answer options; and the teacher's operation of the answer option setting switch 134e_5 sets five answer options. The teacher operates the answer option setting switch 134e_2 to set two answer options for the question 1 described above, while operating the answer option setting switch 134e_3 to set three answer options for the question 2 described above. The teacher may operate one of the answer option setting switches 134e_1 to 134e_6 to set a desired number of answer options for the question 3 described above. At step S210T of waiting for setting the answer options, the tablet 30 waits until the teacher operates one of the answer option setting switches 134e. The tablet 30 then wirelessly transmits answer options specification data reflecting the operation of one of the answer option setting switches 134e from its transmitter/receiver 360 to the transmitter/receiver 29 of the information providing device 20 (FIG. 4) (step S220T). The answer options specification data is wirelessly transmitted from the tablet 30 to the information providing device 20, after the information providing device 20 receives the imaging adjustment data from the tablet 30. The tablet 30 thus wirelessly transmits the answer options specification data to the information providing device 20 in the specified time interval of data transmission after reception of data including the identification signal for the tablet 30 and the transmission approval signal from the information providing device 20 as described in FIG. 7.

The information providing device 20 waits for reception of the answer options specification data from the tablet 30 (step S210C) and then wirelessly transmits the received answer options specification data from its transmitter/receiver 29 to the transmitter/receiver 430 of each individual response clicker 40 (FIG. 6) (step S220C). The information providing device 20 follows the sequence described in FIG. 7 and wirelessly transmits the answer options specification data with the identification signal for each of the response clickers 40 to the corresponding one of the individual response clickers 40.

The response clicker 40 waits for reception of the answer options specification data from the information providing device 20 (step S210S). The response clicker 40 then activates the data generator/analyzer 412 of the CPU 410 (FIG. 6) to analyze the received answer options specification data and controls initial lighting to light up the button light-emitting lamps 148 of the answer buttons 144 specified by the answer options specification data, in a predetermined color, e.g., in blue (step S220S). For example, when the received answer options specification data reflects the teacher's operation of the answer option setting switch 134e_2 for the question 1, the response clicker 40 controls initial lighting to light up the button light-emitting lamps 148 of the answer buttons 144_1 and 144_2 corresponding to the operated answer option setting switch 134e 2, in blue. In another example, when the received answer options specification data reflects the teacher's operation of the answer option setting switch 134e_3 for the question 2, the response clicker 40 controls initial lighting to light up the button light-emitting lamps 148 of the answer buttons 144_1 to 144_3 corresponding to the operated answer option setting switch 134e 3, in blue. In this manner, the response clicker 40 initially lights up the specified number of answer buttons 144 corresponding to the received answer options specification data, in blue. Such visual indication of the corresponding answer buttons 144 facilitates each individual student to recognize the answer buttons 144 as the available response choices or answer options (step S200S). According to this embodiment, the first option among the answer options is always set to the answer button 144_1, and the last option is set to the answer button 144 corresponding to the answer option setting switch 134e operated by the teacher. When the number of answer options is less than six, the first option among the answer options may be set to a predetermined answer button 144 other than the answer button 144_1, and the same number of consecutive answer buttons 144 from the predetermined answer button 144 as the number of answer options may be initially lit up in blue.

The initial lighting of the answer buttons 144 specified by the received answer options specification data at step S220S enables each of the response clickers 40 to stand by for the student's pressing operation of one of the initially-lit answer buttons 144 to make a response. More specifically, the data generator/analyzer 412 stands by for the student's pressing operation. The data generator/analyzer 412 temporarily stores the initially-lit answer buttons 144 specified by the answer options specification data until a subsequent reset operation. When the answer button 144 actually pressed or operated by the student matches with one of the stored answer buttons 144, the student's pressing operation is validated. When the answer button 144 actually pressed or operated by the student does not match with any of the answer buttons 144 specified by the answer options specification data, on the other hand, the student's pressing operation is invalidated.

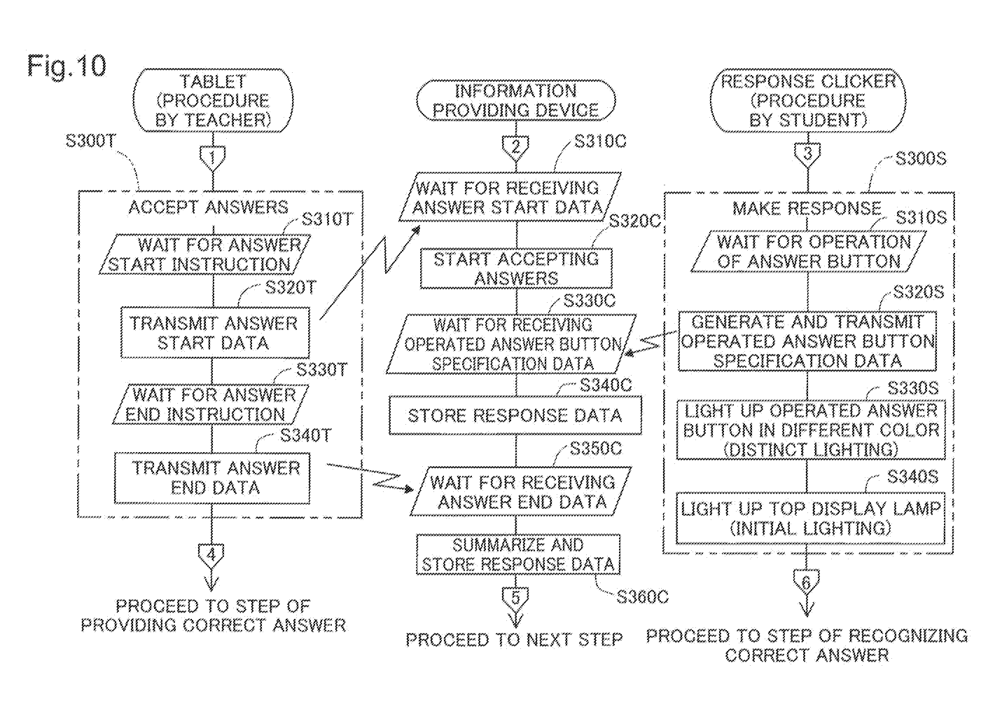

With referring back to FIG. 8, after the tablet 30 sets the answer options and each individual response clicker 40 initially lights up the answer buttons 144 corresponding to the answer options, the teacher accepts the students' answers (step S300T) and each of the students makes a response (step S300S). FIG. 10 illustrates the detailed procedures at the teacher's step of accepting answers and the student's step of making a response, in relation to the operations of the respective devices and the data transmission and reception there between.

As shown in FIG. 10, at step S300T of accepting the students' answers, the tablet 30 waits until the teacher provides answer start instruction (step S310T). When the answer start switch 134a (FIG. 2) is activated by the teacher, the tablet 30 wirelessly transmits the answer start data from its transmitter/receiver 360 to the transmitter/receiver 29 of the information providing device 20 (FIG. 4) (step S320T). The tablet 30 wirelessly transmits the answer start data to the information providing device 20 in the specified time interval of data transmission after reception of data including the identification signal for the tablet 30 and the transmission approval signal from the information providing device 20 as described in FIG. 7.

The information providing device 20 waits for receiving the answer start data from the tablet 30 (step S310C) and starts accepting answers from the individual response clickers 40, in response to reception of the answer start data (step S320C). The information providing device 20 then waits for receiving operated answer button specification data from each of the response clickers 40 (step S330C).

Each of the response clickers 40 waits until the student presses or operates one of the answer buttons 144 (step S310S). The student presses or operates one of the answer buttons 144 initially lit up at step S220S. For example, three answer options are set for the question 2 by the teacher, and the corresponding answer buttons 144_1 to 144_3 are initially lit up on the individual response clickers 40 as described above. The student is accordingly required to operate one of these initially-lit answer buttons 144_1 to 144_3. When the student operates one of these initially-lit answer buttons 144, the response clicker 40 activates the data generator/analyzer 412 of the CPU 410 (FIG. 6) to generate operated answer button specification data for identifying the operated answer button 144 and wirelessly transmits the operated answer button specification data to the information providing device 20 (step S320S). The response clicker 40 wirelessly transmits the operated answer button specification data to the information providing device 20 in the specified time interval of data transmission after reception of data including the identification signal for the corresponding one of the response clickers 40 and the transmission approval signal from the information providing device 20 as described in FIG. 7. The student may press or operate one of the answer buttons 144 on the response clicker 40 prior to the teacher's answer start instruction. In such cases, the response clicker 40 may transmit the operated answer button specification data before the information providing device 20 receives the answer start data from the tablet 30. The information providing device 20, however, starts accepting the answers from the individual response clicker 40 in response to reception of the answer start data (step S320C) and subsequently waits for receiving the operated answer button specification data from each individual response clicker 40 (step S330C). The information providing device 20 thereby accepts the student's pressing operation of one of the initially-lit answer buttons 144 only after the teacher's operation of the answer start switch 134a.

After generating and transmitting the operated answer button specification data at step S320S, the response clicker 40 controls distinct lighting to distinctly light up the button light-emitting lamp 148 of the answer button 144 pressed or operated by the student, in a different color from the color of initial lighting at step S220S (FIG. 9), e.g., in red (step S330S). This enables the student to readily check which of the answer buttons 144 is pressed or operated. The response clicker 40 then controls initial lighting to initially light up the top display lamp 440 (step S340S) and proceeds to the subsequent step of recognizing the correct answer. The initial lighting of the top display lamp 440 at step S340S keeps the top display lamp 440 lit up.

When receiving the operated answer button specification data from each of the response clickers 40, the information providing device 20 stores the received operated answer button specification data as response data (step S340C) and waits for reception of the answer end data from the tablet 30 (step S350C). The information providing device 20 stores the operated answer button specification data in correlation to the identification signal for the response clicker 40 as the transmission source of the operated answer button specification data, as the response data. When receiving the answer end data from the tablet 30, the information providing device 20 summarizes the response data and stores the summarized data (step S360C) with stopping accepting data received from any of the response clickers 40. The information providing device 20 may be configured to wirelessly transmit the answer end data received from the tablet 30 to the individual response clickers 40 or may be configured to wirelessly transmit the stored response data or the stored summarized data to the tablet 30. The response data or the summarized data stored in the information providing device 20 may be output to and displayed on the TV display 50 or may be displayed on the tablet operation unit 34 of the tablet 30 in a manner visible to only the teacher.

After transmitting the answer start data at step S320T, the tablet 30 waits until the teacher provides answer end instruction (step S330T). When the answer end switch 134b (FIG. 2) is activated by the teacher, the tablet 30 wirelessly transmits the answer end data from its transmitter/receiver 360 to the transmitter/receiver 29 of the information providing device 20 (step S340T) and proceeds to the subsequent step of providing the correct answer. The tablet 30 wirelessly transmits the answer end data to the information providing device 20 in the specified time interval of data transmission after reception of data including the identification signal for the tablet 30 and the transmission approval signal from the information providing device 20 as described in FIG. 7.

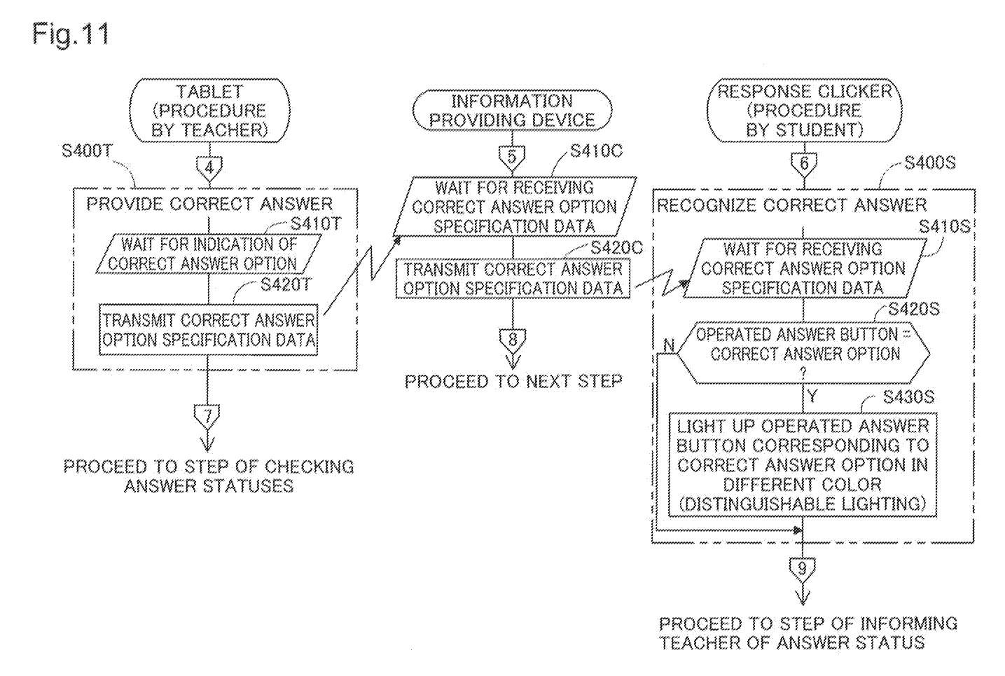

With referring back to FIG. 8, after the tablet 30 provides answer start and answer end instructions and each individual response clicker 40 transmits the operated answer button specification data and initially lights up the top display lamp 440, the teacher provides the correct answer (step S400T) and each of the students recognizes the correct answer (step S400S). FIG. 11 illustrates the detailed procedures at the teacher's step of providing the correct answer and the student's step of recognizing the correct answer, in relation to the operations of the respective devices and the data transmission and reception there between.

As shown in FIG. 11, at step S400T of providing the correct answer, the tablet 30 waits until the teacher indicates the correct answer option (step S410T). The teacher operates one of the answer option setting switches 134e_1 to 134e_6 to specify the correct answer option. When the teacher operates one of the answer option setting switches 134e, the tablet 30 wirelessly transmits correct answer option specification data reflecting the operated answer option setting switch 134e from its transmitter/receiver 360 to the transmitter/receiver 29 of the information providing device 20 (step S420T) and proceeds to the subsequent step of checking the answer statuses. The tablet 30 wirelessly transmits the correct answer option specification data to the information providing device 20 in the specified time interval of data transmission after reception of data including the identification signal for the tablet 30 and the transmission approval signal from the information providing device 20 as described in FIG. 7.

The information providing device 20 waits for receiving the correct answer option specification data from the tablet 30 (step S410C) and wirelessly transmits the received correct answer option specification data to the transmitter/receiver 430 of each individual response clicker 40 (step S420C). The information providing device 20 follows the sequence described in FIG. 7 and wirelessly transmits the correct answer option specification data with the identification signal for each of the response clickers 40 to the corresponding one of the individual response clickers 40.

Each individual response clicker 40 waits for receiving the correct answer option specification data from the information providing device 20 (step S410S). The response clicker 40 then activates the data generator/analyzer 412 of the CPU 410 to analyze the received correct answer option specification data and determines whether the answer button 144 corresponding to the correct answer option specification data is pressed or operated by the student (step S420S). When the operated answer button 144 matches with the correct answer option, the response clicker 40 controls distinguishable lighting to distinguishably light up the button light-emitting lamp 148 of the operated answer button 144 corresponding to the correct answer option in a different color from the color of initial lighting at step S220S (FIG. 9) and the color of distinct lighting at step S330S (FIG. 10), e.g., in orange (step S430S). Such visual indication facilitates the student selecting the correct answer option to recognize that the student's answer is correct. When the operated answer button 144 does not match with the correct answer option, on the other hand, the button light-emitting lamp 148 of the operated answer button 144 corresponding to the wrong answer option is kept in the color of distinct lighting at step S330S, e.g., in red. Such visual indication facilitates the student selecting the wrong answer option to recognize that the student's answer is wrong. After the lighting control, the response clicker 40 proceeds to the subsequent step of informing of the answer status.

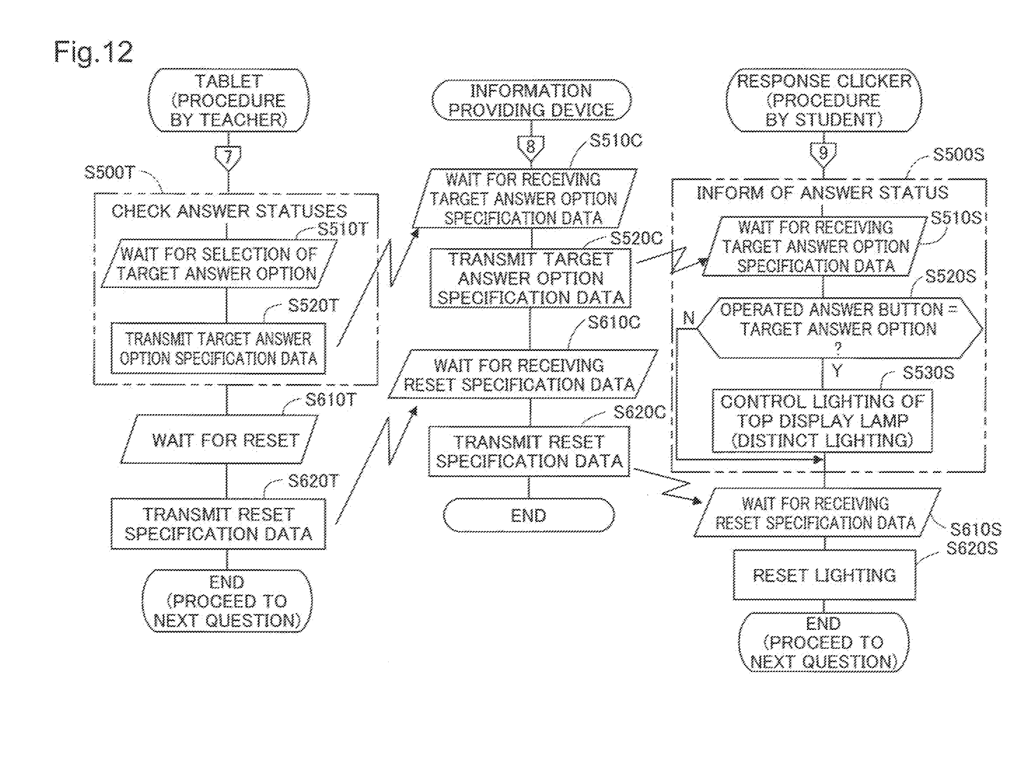

With referring back to FIG. 8, after the tablet 30 provides the correct answer and each individual response clicker 40 recognizes the correct answer, the teacher checks the answer statuses of the individual students (step S500T) and each of the students informs the teach of the student's answer status with the response clicker 40 (step S500S). FIG. 12 illustrates the detailed procedures at the teacher's step of checking the answer statuses and the student's step of informing the teacher of the student's answer status with the response clicker 40, in relation to the operations of the respective devices and the data transmission and reception there between.

As shown in FIG. 12, at step S500T of checking the answer statuses, the tablet 30 waits until the teacher provides instruction on checking the answer statuses (step S510T). This operation of checking the answer statuses enables the teacher to check which of the answer options is selected by each student. The teacher sequentially operates the answer status check switch 134d (FIG. 2) and one of the answer option setting switches 134e_1 to 134e_6 to start this checking operation. The tablet 30 then transmits a target answer option specification data reflecting the answer option setting switch 134e operated after the answer status check switch 134d by the teacher from its transmitter/receiver 360 to the transmitter/receiver 29 of the information providing device 20 (step S520T). When the teacher operates a plurality of the answer option setting switches 134e after the answer status check switch 134d, target answer option specification data reflecting each of the operated answer option setting switches 134e is wirelessly transmitted at step S520T. The tablet 30 wirelessly transmits the target answer option specification data to the information providing device 20 in the specified time interval of data transmission after reception of data including the identification signal for the tablet 30 and the transmission approval signal from the information providing device 20 as described in FIG. 7.

The information providing device 20 waits for receiving the target answer option specification data from the tablet 30 (step S510C) and wirelessly transmits the received target answer option specification data to the transmitter/receiver 430 of each individual response clicker 40 (step S520C). The information providing device 20 follows the sequence described in FIG. 7 and wirelessly transmits the target answer option specification data with the identification signal for each of the response clickers 40 to the corresponding one of the individual response clickers 40.

Each individual response clicker 40 waits for receiving the target answer option specification data from the information providing device 20 (step S510S). The response clicker 40 then activates the data generator/analyzer 412 of the CPU 410 to analyze the received target answer option specification data and determines whether the answer button 144 corresponding to the target answer option specification data is pressed or operated by the student (step 520S). When the operated answer button 144 matches with the target answer option, the response clicker 40 controls distinct lighting of the top display lamp 440 in a different mode from the mode of initial lighting at step S340S (FIG. 10), e.g., blinking (step S530S). Such visual indication of the top display lamp 440 informs the teacher of which of the students selects which of the answer options.

After the data transmission at step S520T, the tablet 30 waits until the teacher provides reset instruction (step S610T). The reset instruction makes the processing flow proceed to a next question. In response to the teacher's operation of the reset switch 134g (FIG. 2), the tablet 30 wirelessly transmits reset specification data from its transmitter/receiver 360 to the transmitter/receiver 29 of the information providing device 20 (step S620T) and terminates the processing flow. The tablet 30 wirelessly transmits the reset specification data to the information providing device 20 in the specified time interval of data transmission after reception of data including the identification signal for the tablet 30 and the transmission approval signal from the information providing device 20 as described in FIG. 7.

The information providing device 20 waits for receiving the reset specification data from the tablet 30 (step S610C) and wirelessly transmits the received reset specification data to the transmitter/receiver 430 of each individual response clicker 40 (step S620C). The information providing device 20 follows the sequence described in FIG. 7 and wirelessly transmits the reset specification data with the identification signal for each of the response clickers 40 to the corresponding one of the individual response clickers 40.

The response clicker 40 waits for receiving the reset specification data from the information providing device 20 (step S610S). The response clicker 40 then activates the lighting controller 414 of the CPU 410 to reset the lighting and turn off the button light-emitting lamps 148 of the answer buttons 144 and the top display lamp 440, based on the received reset specification data (step S620S), and terminates the processing flow.

The execution order of step S400T of providing the correct answer and step S500T of checking the answer statuses on the tablet 30 may be determined by which of the answer option setting switch 134e and the answer status check switch 134d is operated first by the teacher. The teacher may skip either or both of these steps S400T and S500T by operating the reset switch 134g. After the teacher's operation of the reset switch 134g, the students are not required to operate the response clickers 40, until the teacher sets and provides a next question and answer options and provides answer start instruction. In this time period, data transmission and reception may thus be performed only between the information providing device 20 and the tablet 30 as described previously. Alternatively, with the aim of supporting education, the sequence of FIG. 7 may be continued to allow data transmission and reception between the information providing device 20 and the tablet 30 and between the information providing device 20 and each individual response clicker 40.

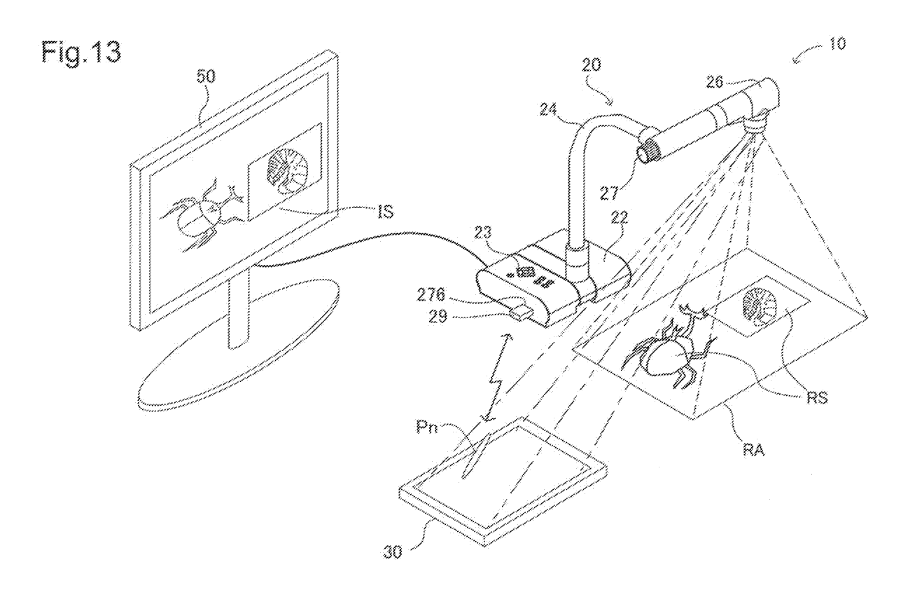

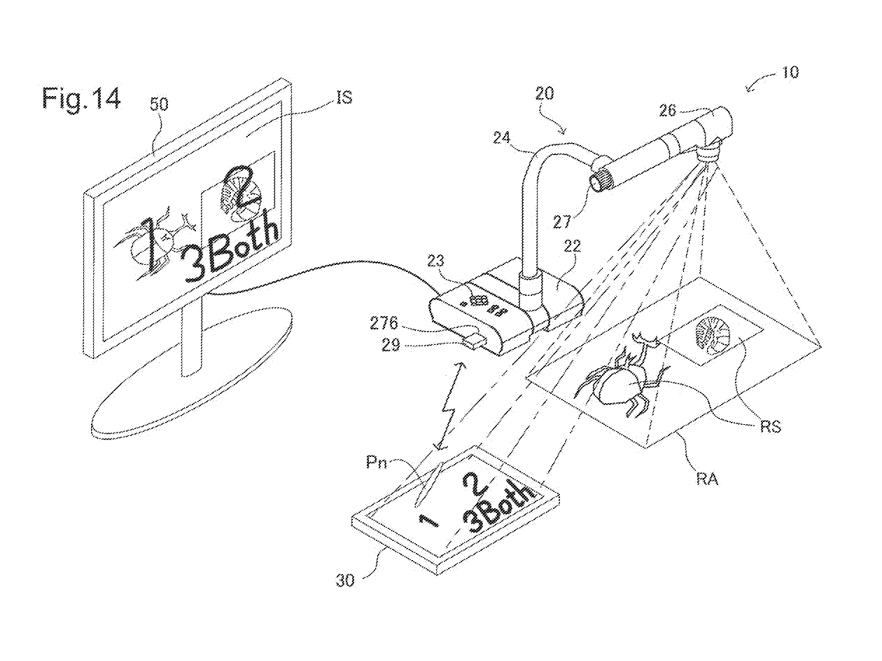

In the information providing system 10 for education support as described above, the tablet operation unit 34 (FIG. 2) of the tablet 30 is set as the teacher's drawing area by the operation of the drawing switch 132. FIG. 13 illustrates the relationship between the drawing area of the tablet 30 and the imaging area RA of the information providing device 20. As illustrated, the tablet operation unit 34 of the tablet 30 corresponds to the imaging area RA, so that the teacher can provide a question and provide a correct answer as described previously with reference to FIG. 8, while making a drawing related to the question. FIG. 14 illustrates a state of providing the image including the teacher's drawing.

As illustrated in FIG. 13, the teacher can recognize the correlation of the drawing position of the tablet pen Pn and the position in the imaging area RA of the information providing device 20. When the teacher provides the students with the question 2 described above, i.e., the question of whether the beetle passes the winter in the form of adult, in the form of grub, or in both the form of adult and the form of grub, the teacher draws a numeral “1” corresponding to the first answer option with the tablet pen Pn over the image of the specimen of adult beetle on the tablet operation unit 34 as illustrated in FIG. 14. The teacher also draws a numeral “2” corresponding to the second answer option with the tablet pen Pn over the image of the photograph of grub on the tablet operation unit 34 and draws a numeral “3” and a word “Both” corresponding to the third answer option at any arbitrary position on the tablet operation unit 34. The tablet 30 wirelessly transmits drawing track data of the drawn image from its transmitter/receiver 360 to the information providing device 20. The drawing track data is wirelessly transmitted in the specified time interval of repeated data transmission from the tablet 30 described in FIG. 7.

The information providing device 20 activates the image composer 236 of the CPU 230 (FIG. 4) to combine the image of the material RS in the imaging area RA with the drawn image represented by the drawing track data transmitted from the tablet 30, i.e., the drawn image including the numeral “1”, the numeral “2”, the numeral “3” and the word “Both” described above, and outputs data of the composite image to the TV display 50. The teacher can thus provide the students with the answer options for the question 2 together with the image of the specimen of adult beetle and the image of the photograph of grub. The teacher may draw the numerals and the word after operating the answer start switch 134a to provide answer start instruction for accepting answers from the students.

In the information providing system 10 of the above embodiment, when the teacher provides an image of the material taken with the camera of the information providing device 20, asks a question, and checks the students' responses to the question, the teacher operates the answer option setting switches 134e of the tablet 30 to set a plurality of answer options for the question, for example, the answer option setting switch 134e_1 to set the first answer option to the answer option setting switch 134e_3 to set the last answer option (step S210T, FIG. 9). The teacher is allowed to set the answer options, such that the number of answer options is equal to or less than the number of the answer buttons 144 provided on the response clicker 40. The teacher as the questioner may thus arbitrarily change the number of answer options set for a question every time setting the question. The information providing system 10 of the embodiment accordingly enhances the versatility for the teacher to set a question to be asked to the students.

In the information providing system 10 of the embodiment, when the teacher operates the tablet 30 to set a plurality of answer options for a question, the tablet 30 wirelessly transmits answer options specification data representing the plurality of answer options set by the teacher from its transmitter/receiver 360 to the transmitter/receiver 29 of the information providing device 20 (step S220T, FIG. 9). Each individual response clicker receives the answer options specification data via its transmitter/receiver 430 from the transmitter/receiver 29 of the information providing device 20 serving as the relay station (step S210S, FIG. 9). The response clicker 40 then initially notifies the students of the answer buttons 144 respectively corresponding to the plurality of answer options specified by the received answer options specification data by lighting the button light-emitting lamps 148 of the respective answer buttons 144 in blue (step S220S, FIG. 9). Such visual indication enables each individual student who operates the answer buttons 144 provided on the individual response clicker 40 to readily recognize the answer buttons 144 initially notified by lighting in blue as the valid answer buttons 144 for the question operable by the student. The information providing system 10 of the embodiment accordingly enhances the convenience for the students who operate the individual response clickers 40 to answer the question.

In the information providing system 10 of the embodiment, when the teacher as the questioner makes a drawing on the tablet operation unit 34 of the tablet 30, the tablet 30 wirelessly transmits drawing track data representing the teacher's drawing track from its transmitter/receiver 360 to the information providing device 20 (FIG. 14). Since the drawing track data is high volume data, the wireless transmission of the drawing track data from the tablet 30 to the information providing device 20 is performed by accumulation of the specified time interval of data transmission after reception of data including the identification signal for the tablet 30 and the transmission approval signal from the information providing device 20 as described in FIG. 7. The information providing device 20 outputs a composite image obtained by combining an image of a material with a drawn image represented by the received drawing track data to the TV display 50 to provide the students with the composite image. In the information providing system 10 of the embodiment, the drawing track obtained by the teacher's drawing operation with the tablet 30 can thus be related to the question. This enables the teacher to provide the students as the audience or responders with the composite image including the drawn image that relates the original image of the material to the question, thus further enhancing the versatility for the teacher as the questioner.

In the information providing system 10 of the embodiment, the tablet operation unit 34 of the tablet 30 is correlated to the imaging area RA of the information providing device 20. As shown in FIG. 14, the teacher is thus allowed to distinctly draw a plurality of answer options over the image taken with the camera to generate a composite image. This enables each of the students to visually and distinctly recognize the plurality of answer options, i.e., the first answer option to the last answer option, together with the image of the material in the composite image, thus further enhancing the convenience for the students. Since the drawing track data specifying the plurality of answer options in a distinct manner is high volume data, the wireless transmission of the drawing track data from the tablet 30 to the information providing device 20 is performed by accumulation of the specified time interval of data transmission after reception of data including the identification signal for the tablet 30 and the transmission approval signal from the information providing device 20 as described in FIG. 7.

In the information providing system 10 of the embodiment, the transmitter/receiver 29 of the information providing device 20 is used as the relay station for data transmission and reception. This does not require any additional data forwarding system or its control to allow data transmission between the tablet 30, the information providing device 20 and the individual response clickers 40, thus advantageously simplifying the entire system configuration and the control. The information providing device 20 serving as the relay station is allowed to summarize the answers of the students as the audience or responders who operate the answer buttons 144 provided on the individual response clickers 40 in correlation to the plurality of answer options set on the tablet 30 by the teacher as the questioner.

In the information providing system 10 of the embodiment, each individual response clicker 40 distinctly lights up the answer button 144 actually pressed or operated by the student in a different color from the color of initial lighting, e.g., in red, among the answer buttons 144 lit in blue by initial notification as the available response choices or answer options (step S330S, FIG. 10). Such visual indication facilitates the student to check which of the answer buttons 144 is operated by the student after the operation.

In the information providing system 10 of the embodiment, when the teacher operates the tablet 30 to set a correct answer option to the question (step S410T, FIG. 11), the tablet 30 wirelessly transmits correct answer option specification data for specifying the correct answer option set by the teacher from its transmitter/receiver 360 to the transmitter/receiver 29 of the information providing device 20 (step S420T, FIG. 11). Each individual response clicker 40 receives the correct answer option specification data from the transmitter/receiver 29 of the information providing device 20 serving as the relay station (step S410S, FIG. 11). When the answer button 144 actually pressed or operated by the student and distinctly lit in red among the answer buttons 144 lit in blue by initial notification matches with the correct answer button 144 specified by the received correct answer option specification data, the response clicker 40 distinguishably notifies the student of the correct answer button 144 by lighting up the operated correct answer button 144 in a different color, e.g., in orange (step S430S, FIG. 11). Such visual indication facilitates the student operating the response clicker 40 to recognize that the operated answer button 144 matches with the correct answer button corresponding to the correct answer option to the question, i.e., that the student selects the correct answer option. The information providing system 10 of the embodiment accordingly enhances the student's motivation and gives the student a sense of achievement.

In the information providing system 10 of the embodiment, each individual response clicker 40 is designed to have the top display lamp 440 inside the colored translucent top light-emitting unit 42. When the student presses or operates any of the answer buttons 144 lit in blue by initial notification as the answer options, the response clicker 40 initially lights up the top display lamp 440 (step S340S, FIG. 10). The information providing system 10 of the embodiment accordingly enables the teacher to readily recognize each student who makes a response to the question by such light emission of the top display lamp 440 of the response clicker 40 operated by the student.

The information providing system 10 of the embodiment also enables the teacher to check which of the students actually presses or operates which of the answer buttons 144. The teacher operates one of the answer option setting switches 134e provided on the tablet 30 to set the answer button 144 corresponding to the answer option as the object to be checked (target answer option) (step S510T, FIG. 12). The tablet 30 wirelessly transmits target answer option specification data for specifying the target answer option set by the teacher from its transmitter/receiver 360 to the transmitter/receiver 29 of the information providing device 20 (step S520T, FIG. 12). Each individual response clicker 40 receives the target answer option specification data from the transmitter/receiver 29 of the information providing device 20 serving as the relay station (step S510S, FIG. 12). When the answer button 144 actually pressed or operated by the student among the answer buttons 144 lit in blue by initial notification matches with the target answer button 144 specified by the received target answer option specification data, the response clicker 40 control lighting of the top display lamp 440 (step S530S, FIG. 12). Such visual indication of the top display lamp 440 facilitates the teacher to recognize which of the students selects the target answer option among the answer options set to the question. While visually recognizing the response clicker 40 with the lit top display lamp 440, the teacher can check the face, the expression, and the attitude of the student. The information providing system 10 of the embodiment accordingly enables the teacher to check the degree of understanding of each student.

In the information providing system 10 of the embodiment, the top display lamp 440 of the response clicker 40 is lit distinctly in a different mode from the mode of initial lighting, e.g., blinking. Such visual indication facilitates the teacher to check which of the students presses or operates the operation button 144 corresponding to the target answer option in a distinguishable manner.

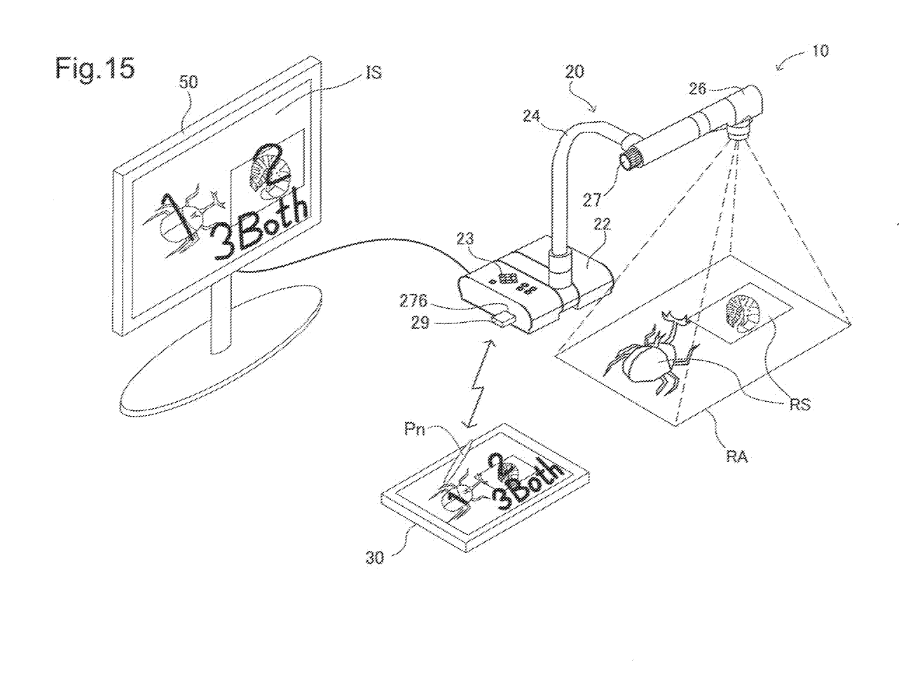

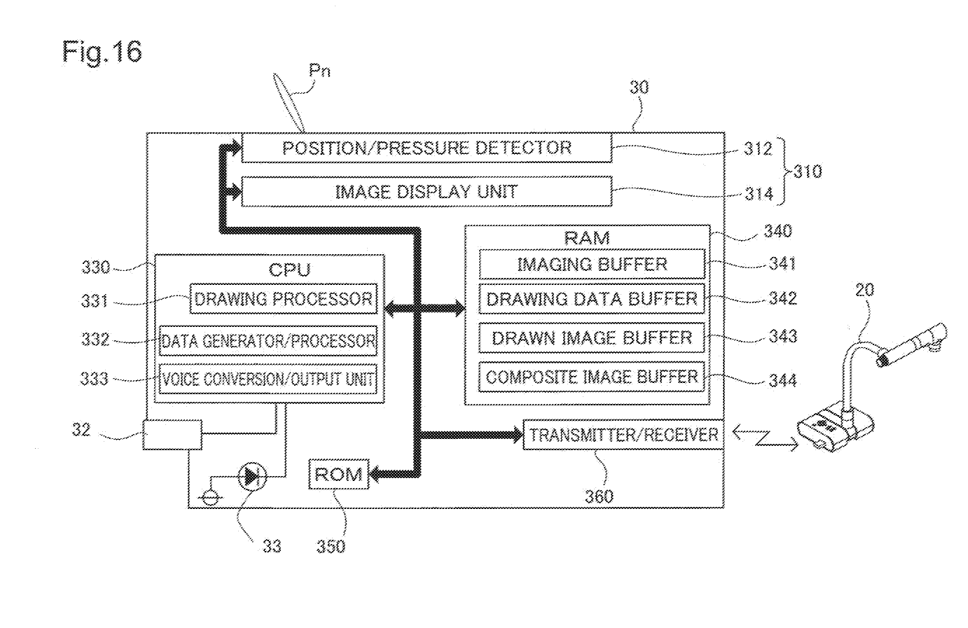

The foregoing describes the invention in detail with reference to one embodiment. The invention is, however, not limited to the above embodiment but various modifications and variations may be made to the embodiment without departing from the scope of the invention. FIG. 15 illustrates the system configuration of the information providing system 10 according to one modification. FIG. 16 is a block diagram illustrating the internal structure of the tablet 30 according to the modification.

As illustrated in FIG. 15, in the information providing system 10 of the modification, the tablet 30 may be configured to display the image of the material RS taken by the information providing device 20 and the composite image including the drawn image on the tablet operation unit 34 of the tablet 30 as well as on the TV display 50. In order to allow the display of the image of the material RS and the composite image, the tablet 30 additionally has an imaging buffer 341 and a composite image buffer 344 provided in the RAM 340 as shown in FIG. 16. The tablet 30 receives the image data of the material RS placed in the imaging area RA from the information providing device 20 via its transmitter/receiver 360 and stores the received image data in the imaging buffer 341. The tablet 30 displays the image of the material RS taken by the information providing device 20 on the tablet operation unit 34, in response to the teacher's operation of the drawing switch 132. The tablet 30 then accepts the teacher's drawing with the tablet pen Pn and wirelessly transmits the drawing track data representing the drawn image to the information providing device 20 as described previously. The tablet 30 subsequently combines the image data with the drawing track data as composite image data, stores the composite image data in the composite image buffer 344 and displays a composite image on the tablet operation unit 34 based on the stored composite image data.

In the information providing system 10 of the modification, the teacher is allowed to make a drawing related to setting of answer options for a question, over the image of the material displayed on the tablet operation unit 34 of the tablet 30. This configuration further enhances the versatility and the convenience.

There may be various other modifications. The information providing device 20 illustrated in FIG. 1 is employed as the information providing device of the embodiment, but any of various other information providing devices may be employed for the same purpose. For example, the information providing device may be equipped with a table which the material RS is placed on. In another example, a display device (e.g., projector) for displaying the image taken by the information providing device may be integrated with the information providing device. According to other modifications, the base of the camera head 26 shown in FIG. 1 may be structured to pivotally rotate; the support rod 24 may be structured to be rotatable about two different axes; or the support rod 24 may be structured to pivotally rotate.

In the above embodiment, the liquid crystal panel is employed for the tablet operation unit 34 of the tablet 30. The liquid crystal panel may be replaced with another suitable material, e.g., organic EL panel or electronic paper. Additionally, the projected capacitive touchscreen is employed for the tablet operation unit 34. Any of various other types of touchscreens, e.g., resistive touchscreen, surface acoustic wave touchscreen, electromagnetic touchscreen or optical imaging touchscreen, may be used for the same purpose. For example, in the resistive touchscreen employed for the tablet operation unit 34 of the tablet 30, a voltage is applied to one of two resistive sheets or transparent electrodes facing each other. When both the electrodes come into contact with each other by the operation of the teacher, the position of conduction between the two electrodes is detected as a voltage change.

In the above embodiment, the TV display 50 is employed as the image display device to display images. This is, however, not restrictive, but any of various other image display devices, such as a projector or a liquid crystal display may be used for the same purpose. Any of such modifications has the similar advantageous effects to those of the above embodiment.

In the above embodiment, the teacher operates the tablet operation unit 34 of the tablet 30 to make a drawing related to setting of answer options for a question. According to one modification, the teacher may manually write down the question statement on the tablet operation unit 34. The question statement data may be wirelessly transmitted in the form of drawing track data or text data generated by conversion of the drawing track data from the tablet 30 to the information providing device 20 by the method described above. The information providing device 20 provides the students with the question statement displayed on the TV display 50. This enables the teacher as the questioner to create an appropriate question according to the students' level of learning or understanding and provide the students with the created question together with the image of the material. This further enhances the versatility. Creating the question statement on the tablet operation unit 34 and transmitting and displaying the data of the question statement may be performed before setting the answer options (step S210T, FIG. 9). The question statement may be combined with the image of the material and displayed as a composite image on the TV display 50. Alternatively, the display screen of the TV display 50 may be divided into two areas; the question statement may be displayed in one area and the image of the material may be displayed in the other area.

In the above embodiment, the transmitter/receiver 29 of the information providing device 20 is used as the relay station to wirelessly transmit and receive data between the information providing device 20 and the tablet 30 and between the information providing device 20 and each individual response clicker 40. According to another embodiment, the information providing device 20, the tablet 30 and the individual response clickers 40 may be interconnected by a wireless LAN to enable mutual and individual wireless data transmission and reception. This configuration enables required data, e.g., the answer options specification data, the answer start data, and the answer end data, to be directly transmitted from the tablet 30 to the individual response clickers 40. The operated answer button specification data may be transmitted from each individual response clicker 40 to the information providing device 20 in the specified time interval of data transmission after reception of data including the identification signal for each individual response clicker 40 and the transmission approval signal from the information providing device 20 as described above.

In the above embodiment, the answer buttons 144 provided on the response clicker 40 corresponding to the answer options specified by the teacher's operation of the answer option settings switches 134e on the tablet 30 are initially lit up (step S220S, FIG. 9). Another technology may be employed for the notification. According to another embodiment, each of the answer buttons 144 may be structured to have the vibration function on its operating surface, and each student may be notified of the answer buttons 144 corresponding to the answer options by the vibration of their operating surfaces. According to yet another embodiment, the response clicker 40 may be provided with a speaker, and each student may be notified of the answer buttons 144 corresponding to the answer options by voice.

In the above embodiment, the touchscreen 310 with the display function as the liquid crystal display (image display unit 314, FIG. 5) is employed for the tablet operation unit 34 of the tablet 30. The touchscreen 310 may be replaced with a conventional touchscreen with no display function. The conventional touchscreen cannot be used to provide a question or answer options for the question with drawing numerals, words or figures but can still be used to set answer options and provide answer start instruction or answer end instruction. Employing the conventional touchscreen advantageously reduces the cost. Switch icons in relation to each of the function switches 130, for example, switch icons for providing instructions in relation to the clicker directing switch 134 as shown in FIG. 2 and switch icons (not shown) for adjusting the imaging conditions in relation to the camera switch 131 may be printed on the surface of the tablet operation unit. The switch icons printed on the surface of the tablet operation unit may be correlated to each of the function switches 130 to be operated. Even such a tablet operation unit without display function enables generation and transmission of, for example, answer start data in response to the teacher's press of a switch icon corresponding to the answer start switch 134a.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An information providing system that provides each responder in audience with an image of a material taken with a camera and allows interaction with the responder, the information providing system comprising:
an information providing device configured to take the image of the material with the camera and output the image to an image display unit to be visible to the audience;
a specific device operable by a questioner who asks a question to the audience; and
a plurality of response devices provided for individual responders in ii the audience and configured to have a plurality of answer operation elements operable by each individual responder to answer the question, wherein
the information providing device, the specific device and the plurality of response devices are arranged to allow data transmission and reception, wherein
the specific device includes:
an answer options specifier operable by the questioner to set a plurality of answer options as available responses to the question such that the number of the answer options is equal to or less than the number of the answer operation elements provided on each of the response devices; and
a specific device transmitter/receiver involved in data transmission and reception and configured to transmit answer options specification data for specifying the plurality of answer options set by the answer options specifier,
each of the response devices includes:
a response device transmitter/receiver involved in data transmission and reception and configured to receive the answer options specification data transmitted from the specific device, and
each of the response devices receives each individual responder's operation of each of the plurality of answer operation elements corresponding to each of the plurality of answer options specified by the received answer options specification data.

2. The information providing system according to claim 1, wherein
each of the response devices further includes a notifier involved in notification of information to each individual responder and configured to provide initial notification that initially notifies the individual responder of the answer operation elements respectively corresponding to the plurality of answer options specified by the received answer options specification data.

3. The information providing system according to claim 1, wherein
the specific device is structured as a tablet terminal that allows the questioner to make a drawing and transmits drawing track data representing a track of the drawing via the specific device transmitter/receiver to the information providing device, and
the information providing device receives the drawing track data, generates a composite image by laying a drawn image represented by the received drawing track data over the image taken with the camera, and outputs the generated composite image to the information display unit.

4. The information providing system according to claim 3, wherein
the drawing track data includes a character drawn image created by the questioner using the specific device as the tablet terminal.

5. The information providing system according to claim 1, wherein
the information providing device further includes a wireless data communication controller and allows wireless data transmission and reception between the specific device and the plurality of response devices via the wireless data communication controller,
the specific device wirelessly transmits the answer options specification data via the specific device transmitter/receiver to the wireless data communication controller of the information providing device, and
each of the response devices wirelessly receives the answer options specification data via the response device transmitter/receiver from the wireless data communication controller of the information providing device.

6. The information providing system according to claim 2, wherein
each of the response devices generates operated answer operation element specification data for specifying one of the answer operation elements operated by each individual responder among the plurality of initially notified answer operation elements and transmits the operated answer operation element specification data via the response device transmitter/receiver to the information providing device, and
the notifier of the response device provides distinct notification that distinctly notifies the individual responder of the answer operation element operated by the individual responder among the plurality of initially ii notified answer operation elements.

7. The information providing system according to claim 6, wherein
the specific device further includes a correct answer option specifier configured to set a correct answer option to the question by the questioner's operation,
the specific device transmits correct answer option specification data for specifying the correct answer option set by the correct answer option specifier via the specific device transmitter/receiver to at least the information providing device,
each of the response devices receives the correct answer option specification data via the response device transmitter/receiver through the information providing device or directly from the specific device, and
when the answer operation element operated by the individual responder among the plurality of initially notified answer operation elements matches with an answer operation element specified by the received correct answer option specification data, the notifier of the response device distinctly notifies the individual responder of the matching answer operation element operated by the individual responder.

8. The information providing system according to claim 6, wherein
each of the plurality of answer operation elements provided on each of the response devices has a color light-emitting element configured to change color of light, and
the notifier of the response device controls lighting of the color light-emitting element to light up the color light-emitting element in different colors for the initial notification and for the distinct notification.

9. The information providing system according to any one of claims 2, wherein
each of the response devices has a light-emitting element configured to externally emit light, and a light emission controller configured to provide initial lighting that initially lights up the light-emitting element, when one of the initially notified answer operation elements is operated by each individual responder.

10. The information providing system according to claim 9, wherein
the specific device further includes an arbitrary answer option specifier configured to set an arbitrary answer option among the plurality of answer options by the questioner's operation,
the specific device transmits arbitrary answer operation specification data for specifying the arbitrary answer option set by the arbitrary answer option specifier via the specific device transmitter/receiver to at least the information providing device,
each of the response devices receives the arbitrary answer operation specification data via the response device transmitter/receiver through the information providing device or directly from the specific device, and
when the answer operation element operated by the individual responder among the plurality of initially notified answer operation elements matches with an answer operation element specified by the received arbitrary answer option specification data, the light emission controller of the response device controls lighting of the light-emitting element distinguishably from the initial lighting.

11. The information providing system according to claim 10, wherein
the light emission controller of the response device controls lighting of the light-emitting element to distinguishably light the light-emitting element in a different lighting mode from the initial lighting.
